(19) United States
(12) Patent Application Publication
(10) Pub. No.: US 2014/0376611 A1
(43) Pub. Date: Dec. 25, 2014

(54) ADAPTIVE COLOR TRANSFORMS FOR VIDEO CODING

(71) Applicant: QUALCOMM Incorporated, San Diego, CA (US)

(72) Inventors: Woo-Shik Kim, San Diego, CA (US); Joel Sole Rojals, La Jolla, CA (US); Marta Karczewicz, San Diego, CA (US)

(21) Appl. No.: 14/309,867

(22) Filed: Jun. 19, 2014

Related U.S. Application Data
(60) Provisional application No. 61/838,152, filed on Jun. 21, 2013.

(51) Int. Cl. H04N 19/12; H04N 19/176; H04N 19/136

(52) U.S. Cl. CPC H04N 19/00078; H04N 19/00139; H04N 19/00278
USPC 375/240.02

(57) ABSTRACT

A device for coding video data includes a memory and at least one processor configured to determine a cost associated with a plurality of color transforms associated with a coding unit, determine a cost associated with a plurality of color transforms associated with a coding unit, select a color transform of the plurality of color transforms having a lowest associated cost, transform a first block of video data having a first, Red, Green, Blue (RGB) color space to produce a second block of video data having a second color space using the selected color transform of the plurality of color transforms, and encode the second video block having the second color space.

This application claims priority to U.S. Application No. 61/838,152, filed Jun. 21, 2013, the entire contents of which are incorporated herein in their entirety.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4. ITU-T H.263, ITU-T H.264/MPEG-4, Part 10, Advanced Video Coding (AVC), the High Efficiency Video Coding (HEVC) standard, and extensions of such standards, such as the scalable video coding (SVC), multiview video coding (MVC), and Range Extensions. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques related to a video coder that is configured to transform between samples of a block of video data having a first color space to a block of samples of having a second color space. The color spaces may include RGB (red, green, blue) YCbCr, YCgCo, or another color space. As part of video preprocessing, it may be desirable to work with video having an RGB color space. Once preprocessing is finished, the video is often converted to a different color space, such as YCbCr format. Color conversion from one color space (e.g., RGB) to another color space may cause color distortion, which a user may perceive as subjective quality degradation. One or more of the techniques of this disclosure are directed to color transforms that may improve compression efficiency and/or reduce distortion when compressing video from an RGB video input source to video having a different color space and vice versa.

In accordance with the techniques of this disclosure, a method of encoding video data includes determining a cost associated with a plurality of color transforms with a coding unit, and selecting a color transform of the plurality of color transforms having a lowest associated cost. The method further includes adaptively transforming a first block of video data having a first, Red, Green, Blue (RGB) color space to produce a second block of video data having a second color space using the selected color transform of the plurality of color transforms, and encoding the second video block having the second color space.

In another example in accordance with the techniques of this disclosure, a method of decoding video data includes receiving syntax data associated with a coded unit in a bitstream, the syntax data indicative of one of a plurality of inverse color transforms, selecting an inverse color transform of the plurality of inverse color transforms based on the received syntax data, inversely transforming a first block of video data having a first color space to a second block of video having a second, red, green, blue (RGB) color space using the selected inverse color transform of the plurality of inverse color transforms, and decoding the second video block having the second, RGB color space.

Another example of this disclosure describes device for encoding video data that includes a memory configured to store video data, and at least one processor configured to: determine a cost associated with a plurality of color transforms associated with a coding unit, select a color transform of the plurality of color transforms having a lowest associated cost, transform a first block of video data having a first, Red, Green, Blue (RGB) color space to produce a second block of video data having a second color space using the selected color transform of the plurality of color transforms, and encode the second video block having the second color space.

Another example of this disclosure describes a device for decoding video data that includes a memory configured to store video data, and at least one processor configured to: receive syntax data associated with a coded unit in a bitstream, the syntax data indicative of one of a plurality of inverse color transforms, select an inverse color transform of the plurality of inverse color transforms based on the received syntax data, inversely transform a first block of video data having a first color space to a second block of video having a second, red, green, blue (RGB) color space using the selected inverse color transform of the plurality of inverse color transforms, and decode the second video block having the second, RGB color space.

Another example of this disclosure describes a device for decoding video. The device includes means for receiving syntax data associated with a coded unit in a bitstream, the syntax data indicative of one of a plurality of inverse color transforms, means for selecting an inverse color transform of the plurality of inverse color transforms based on the received syntax data, means for inversely transforming a first block of video data having a first color space to a second block of video having a second, red, green, blue (RGB) color space using the selected inverse color transform of the plurality of inverse color transforms, and means for decoding the second video block having the second, RGB color space.

In another example, a non-transitory computer-readable storage medium has instructions stored thereon that, when executed, cause at least one processor to: receive syntax data associated with a coded unit in a bitstream, the syntax data indicative of one of a plurality of inverse color transforms, select an inverse color transform of the plurality of inverse color transforms based on the received syntax data, inversely transforming a first block of video data having a first color space to a second block of video having a second, red, green, blue (RGB) color space using the selected inverse color transform of the plurality of inverse color transforms, and decode the second video block having the second, RGB color space.

The details of one or more examples are set forth in the accompanying drawings and the description below. Other features, objects, and advantages will be apparent from the description, drawings, and from the claims.

### BRIEF DESCRIPTION OF DRAWINGS

FIG. 1 is a block diagram illustrating an example video encoding and decoding system that may implement one or more techniques of this disclosure.

FIG. 2 is a block diagram illustrating an example video encoder that may implement techniques for transforming a block of video data having an RGB color space to a block of video data having a second color space using a color transform in accordance with one or more aspects of this disclosure.

FIG. 3 is a block diagram illustrating an example of a video decoder that may implement techniques for transforming video data having a first color space to video data having a second, RGB color space using a color space in accordance with one or more aspects of this disclosure.

FIG. 4 is a block diagram illustrating another example of a video encoder that may utilize techniques for transforming video data having an RGB color space to video data having a second color space using a color transform in accordance with one or more aspects of this disclosure.

FIG. 5 is a block diagram illustrating another example of a video decoder that may utilize techniques for inversely transforming a block of video data having a first color space to a block of video data video data having a second, RGB color space using an inverse color transform in accordance with one or more aspects of this disclosure.

FIG. 6 is a flowchart illustrating a process for transforming video data having an RGB color space to video data having a second color space using a color transform in accordance with one or more aspects of this disclosure.

FIG. 7 is a flowchart illustrating a process for transforming a block of video data having a first color space to a block of video data having a second, RGB color space using an inverse color transform in accordance with one or more aspects of this disclosure.

FIG. 8 is a flowchart illustrating a process for inversely transforming an original block of video data having a first color space to a block of video data having a second, RGB color space.

FIG. 9 is a flowchart illustrating a process for inversely transforming a residual block of video data having a first color space to a block of video data having a second, RGB color space.

FIG. 10 is a flowchart illustrating a process for transforming an original block of video data having a first color space to a block of video data having a second, RGB color space.

FIG. 11 is a flowchart illustrating a process for transforming a residual block of video data having a first color space to a block of video data having a second. RGB color space.

### DETAILED DESCRIPTION

A video coder (i.e. a video encoder or decoder) is generally configured to code a video sequence, which is generally represented as a sequence of pictures. Typically, the video coder uses block-based coding techniques to code each of the sequences of pictures. As part of block-based video coding, the video coder divides each picture of a video sequence into blocks of data. The video coder individually codes (i.e. encodes or decodes) each of the blocks. Encoding a block of video data generally involves encoding an original block of data by generating one or more predictive blocks for the original block, and a residual block that corresponds to differences between the original block and the one or more predictive blocks. Specifically, the original block of video data includes a matrix of pixel values, which are made up of one or more channels of “samples,” and the predictive block includes a matrix of predicted pixel values, each of which are also made of predictive samples. Each sample of a residual block indicates a difference between a sample of a predictive block and a corresponding sample of the original block.

Prediction techniques for a block of video data are generally categorized as intra-prediction and inter-prediction. Intra-prediction (i.e., spatial prediction) generally involves predicting a block from pixel values of neighboring, previously coded blocks. Inter-prediction generally involves predicting the block from pixel values of previously coded pictures.

The pixels of each block of video data each represent color in a particular format, referred to as a “color space.” In other words, the block “has” a particular color space. A color space may also be referred to as a “color space.” A color space is a mathematical model describing a manner in which color can be represented as tuples of numbers. Different video coding standards may use different color spaces for representing video data. As one example, the main profile of the High Efficiency Video Coding (HEVC) video standard, developed by the Joint Collaborative Team on Video Coding (JCT-VC), uses the YCbCr color space to represent the pixels of blocks of video data.

The YCbCr color space generally refers to a color space in which each pixel of video data is represented by three sample components or channels of color information, “Y,” “Cb,” and “Cr.” The Y channel contains luminance (i.e. brightness) data for a particular sample. The Cb and Cr components are the blue-difference and red-difference chrominance components, respectively. YCbCr is often used to represent color in compressed video data because there is strong decorrelation between each of the Y. Cb, and Cr components, meaning that there is little data that is duplicated or redundant among each of the Y, Cb, and Cr channels. Coding video data using the YCbCr color space therefore offers good compression performance in many cases.

Additionally, many video coding techniques utilize a technique, referred to as “chroma subsampling” to further improve compression of color data. Chroma subsampling refers to coding a block of video data using less chroma information than luma information for a block, i.e. using fewer chroma samples relative to the number of luma samples in the same block. Chroma sub-sampling of video data having a YCbCr color space reduces the number of chroma values that are signaled in a coded video bitstream by selectively omitting chroma components according to a pattern. In a block of chroma sub-sampled video data, there is generally a luma sample for each pixel of the block. However, the video coder may only signal the Cb and Cr samples for some of the pixels of the block.

A video coder configured for chroma subsampling interpolates Cb and Cr components for pixels where the Cb and Cr values are not explicitly signaled for chroma sub-sampled blocks of pixels. Chroma sub-sampling works well to reduce the amount of chrominance data without introducing much distortion in blocks of pixels that are more uniform. Chroma sub-sampling works less well to represent video data having widely differing chroma values, and may introduce large amounts of distortion in those cases.

The HEVC Range Extension, which is an extension to the HEVC standard, adds support to HEVC for additional color spaces and chroma sub-sampling formats, as well as for increased color bit-depth. Color bit-depth is the number of bits used to represent a component of a color space. The support for other color spaces may include support for encoding and decoding RGB sources of video data, as well as support for coding video data having other color spaces.

For some applications, such as video preprocessing applications, using color spaces other than YCbCr in HEVC video may be useful. High fidelity video sources, e.g. video cameras, may capture video data using an RGB color space, using separate charge coupled devices (CCDs) that may correspond to each of a red, green, and blue color channel. The RGB color space (and in particular the RGB 4:4:4 color space) represents each pixel as a combination of red, green, and blue color samples.

Video processing software and preprocessing applications may work better with, or may only be compatible with an RGB color space, rather than color components, such as the components of the YCbCr color space. Additionally, some RGB color spaces may include each of the R, G, and B samples for each pixel, i.e. a video coder may not perform chroma sub-sampling. Video blocks without chroma sub-sampling may have better subjective visual quality as compared to video blocks that use a chroma sub-sampling format.

However, RGB suffers from the drawback that there is significant correlation between each of the red, green, and blue color components. Because of the relatively higher color correlation in the RGB color space, the amount of data that is required to represent blocks of video data having an RGB color space may be much greater than blocks of video data represented using other color spaces.

To improve compression performance, a video coder configured in accordance with one or more of the techniques of this disclosure may convert a block of video data having a first color space, such as an RGB color space, to a block of video having a different color space, such as YCbCr or another color space, and vice versa. However, converting to and from RGB to another color space may introduce distortion, which may have negative effects on video quality. The distortion may be a result of differing bit depths between the first and second color spaces. It is also possible for a video coder configured in accordance with one of more of the techniques of this disclosure to convert video data to and from RGB to a different color space without introducing any distortion. One or more of the techniques of this disclosure are directed toward techniques for transforming video data having an RGB color space to a second color space using a color transform to compress the RGB video data without introducing excessive distortion.

One or more of the techniques of this disclosure transform a block of video data having a first color space to a block of video data having a second color space using a color transform. In some examples, a color transform is a matrix, which when multiplied with a matrix of samples of a color space, produces pixels having the color space associated with the color transform matrix. In some examples, the color transform may comprise one or more equations. One or more of the techniques of this disclosure are further directed toward a video coder that may be configured to adaptively transform blocks of video data having an RGB color space to produce blocks of video data having a second color space. The second color space may be one of a plurality of color spaces that the video coder may select from when transforming samples between color spaces.

To determine which of the one or more color spaces to transform the video data having the RGB color space, the video coder may select the transform adaptively, e.g. based on some metric. In some examples, the video coder may determine a cost value associated with each of the color transforms, and may determine the color transform that produces the lowest cost. In another example, the cost may be based on the correlation between each of the color components of a block of RGB video data and the color components of the second color space. The color transform having the lowest associated cost may be the color transform that has color components that are most closely correlated with the RGB color components of the source video. In some examples, a video decoder may select an inverse color transform based on syntax data received from the video encoder. The syntax data may indicate the inverse color transform of the one or more color transforms to apply to one or more blocks of a coded unit of video data.

The HEVC video coding standard defines a tree-like structure that defines blocks of video data. The technique of this disclosure may apply to a variety of different components of the HEVC tree-like structure. In HEVC, a video coder breaks a coded picture (also referred to as a “frame”) into blocks based on the tree structure. Such blocks may be referred to as treeblocks. In some instances, a treeblock may also be referred to as a largest coding unit (LCU). The treeblocks of HEVC may be roughly analogous to macroblocks of previous video coding standards, such as H.264/AVC. However, unlike the macroblocks of some video coding standards, treeblocks are not limited to a certain size (e.g. a certain number of pixels). Treeblocks may include one or more coding units (CUs), which may be recursively divided into sub-coding units (sub-CUs).

Each CU may include one or more transform units (TUs). Each TU may include residual data that has been transformed. In addition, each CU may include one or more prediction units (PUs). A PU includes information related to the prediction mode of the CU. The techniques of this disclosure may apply a color transform to blocks, such as one or more of an LCU, CU, sub-CU, PU, TU, macroblocks, macroblock partitions, sub-macroblocks, or other types of blocks of video data.

A video coder may be configured to perform the techniques of this disclosure at different stages of the video coding process. In one example, a video encoder may apply a color transform to an input video signal, e.g. video blocks having an RGB color space. The video encoder may then operate on the transformed blocks, which have a second color space. For instance, the video encoder may encode the transformed blocks. During decoding, a video decoder may perform a generally reciprocal process to reconstruct blocks having the second color space, and may apply the inverse color transform just before outputting the reconstructed picture.

In another example, a video encoder configured in accordance with the techniques of this disclosure may transform blocks of residual video data having an RGB color space to a second block of video data having a second color space using the selected color transform of the plurality of color transforms. A video decoder configured in a similar manner may apply a selected inverse color transform of the plurality of color transforms to a block of residual data having the second color space to transform the block into a block of residual data having an RGB color space.

A video coder may signal or determine, in a number of different ways, that a particular color transform has been applied to a block of video data. In one example, a video coder may code (i.e., encode or decode), for each block, data (e.g., an index value) indicating the selected transform of the plurality of color transforms was used to transform the block, and the color space associated with that block of video data. The index value may also indicate the selected inverse color transform that a video decoder should apply to inversely transform the block.

In a second example, a video encoder may determine that a single color transform should be used to transform each block of a picture. In this example, the video coder may determine whether or not to apply the color transform to each of the blocks of the picture on an individual basis, e.g. using one or more of the cost-based criteria described elsewhere in this disclosure elsewhere. A video coder may then code data indicating whether or not the single transform has been applied to each of the blocks of the CVS. The encoder encodes data, such as a flag syntax element, indicating that that the single color transform has be applied to a block or plurality of blocks, or that the single color transform has not been applied to the block or a plurality of blocks (i.e. that no transform has been applied to the block). A video decoder decodes data indicating that that the single color transform has be applied to the block or plurality of blocks, or that the single color transform has not been applied to the block or the plurality of blocks, and applies an inverse color transform to the block. In these examples, a first flag value may indicate that the transform has been applied, while a second, different value of the flag syntax element may indicate that no transform has been applied.

In some examples, a video encoder determines that a single color transform should be applied to each of the blocks of the pictures of a CVS. In other words, the video encoder selects a single color transform to apply to all blocks of all pictures of a CVS. The video encoder transforms each of the blocks of the CVS using the determined single color transform. All the blocks of the pictures of the CVS are transformed using the single color transform, and no blocks are untransformed. Because all blocks are transformed using the determined color transform, it may be unnecessary for the video coder to code any data indicating that a particular block has been transformed using the determined color transform.

The color transforms of this disclosure may include, but are not necessarily limited to, an identity transform, a differential transform, a weighted differential transform, a discrete cosine transform (DCT), a YCbCr transform, a YCgCo transform, a YCgCo—R transform, and/or transforms not specifically described herein. Applying an identity transform may be the same as applying no transform at all.

To apply a color transform to a block of video data having an RGB color space, a video encoder may multiply a 3×1 matrix with a color transform matrix. The 3×1 matrix may comprise red, green, and blue color components. The result of the matrix multiplication is a pixel or a set of pixels having a second color space. The video coder may apply the color transform matrix to each pixel of the video block. The video coder may select the appropriate matrix based on cost criteria, as described elsewhere in this disclosure.

During decoding, a video decoder configured in accordance with one or more of the techniques of this disclosure may select an inverse transform matrix based on data signaled in a coded video bitstream. Additionally, the video coder may multiply a 3×1 matrix with the inverse transform matrix. The 3×1 matrix may comprise pixel data for the second color space. The result of the multiplication is a pixel in an RGB color space.

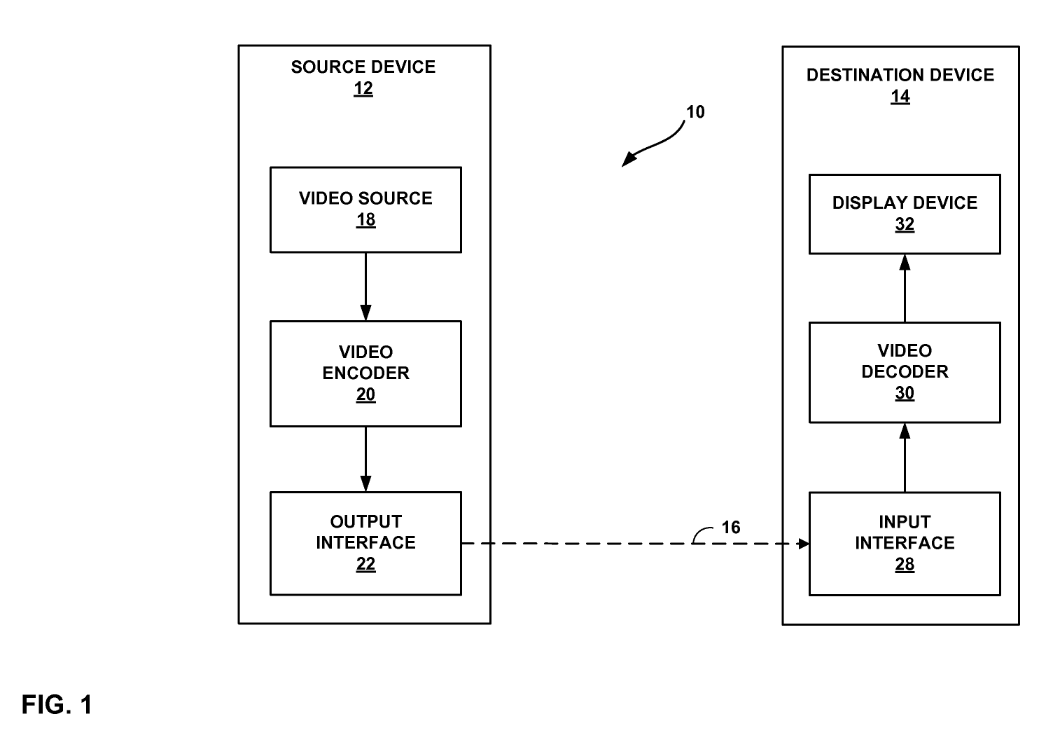

FIG. 1 is a block diagram illustrating an example video encoding and decoding system 10 that may implement techniques for transforming video data having a first representation to video data having a second color space using a color transform in accordance with one or more aspects of this disclosure.

FIG. 1 is a block diagram illustrating an example video encoding and decoding system that may implement techniques for transforming blocks of video data having a first space to produce a second block of video having data having a second color space using a color transform, in accordance with one or more aspects of this disclosure. In the example of FIG. 1, source device 12 includes video source 18, video encoder 20, and output interface 22. Destination device 14 includes input interface 28, video decoder 30, and display device 32. In other examples, a source device and a destination device may include other components or arrangements. For example, source device 12 may receive video data from an external video source 18, such as an external camera. Likewise, destination device 14 may interface with an external display device, rather than including an integrated display device. In accordance with this disclosure, video encoder 20 of source device 12 may be configured to apply the techniques of transforming a first block of data having a first color space to a second block of video data having a second color space using a color transform of a plurality of color transforms, and code the second video block having the second color space.

In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, output interface 22 may output encoded data to a storage device. Similarly, input interface 28 may access encoded data from the storage device. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device (e.g., via streaming or download). The file server may be any type of server capable of storing encoded video data and transmitting that encoded video data to destination device 14. Example file servers include a web server (e.g., for a website), an FTP server, network attached storage (NAS) devices, a Hypertext Transfer Protocol (HTTP) streaming server, or a local disk drive. Destination device 14 may access the encoded video data through a standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

System 10 of FIG. 1 is merely one example. Techniques for transforming a block of data having a first color space to a second block of video data have a second color space using a color transform of a plurality of color transforms may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. In some examples, video source 18 generates computer graphics-based data as the source video, or a combination of live video, archived video, and computer-generated video. In some cases, video source 18 may be a video camera. In some examples, video source 18 may be a video camera. In some examples, source device 12 and destination device 14 may be so-called camera phones or video phones. In various examples, video source 18 may output an input signal having an RGB color space. As mentioned above, however, the techniques described in this disclosure may be applicable to video coding in general, and may be applied to wireless and/or wired applications. In each case, the captured, pre-captured, or computer-generated video may be encoded by video encoder 20. Output interface 22 may output the encoded video information onto computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

In the example of FIG. 1, input interface 28 of destination device 14 receives information from computer-readable medium 16. The information of computer-readable medium 16 may include syntax information defined by video encoder 20 that includes syntax elements that describe characteristics and/or processing of blocks and other coded units, e.g., GOPs. Display device 32 displays decoded video data to a user. Display device 32 may comprise any of a variety of display devices such as a cathode ray tube (CRT) display, a liquid crystal display (LCD), a plasma display, an organic light emitting diode (OLED) display, or another type of display device.

Video encoder 20 and video decoder 30 may operate according to a video coding standard, such as the recently-finalized High Efficiency Video Coding (HEVC), as well as the HEVC Range Extension, developed by the Joint Collaborative Team on Video Coding (JCT-VC). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video coding standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques of this disclosure are implemented partially in software, a device may store instructions for the software in a suitable non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data.

HEVC describes that a video frame or picture may be divided into a sequence of treeblocks (i.e., largest coding units (LCUs) or “coding tree units” (CTUs)). Treeblocks may include luma and/or chroma samples. Syntax data within a bitstream may define a size for the LCUs, which are largest coding units in terms of the number of pixels. In some examples, each of the CTUs comprises a coding tree block of luma samples, two corresponding coding tree blocks of chroma samples, and syntax structures used to code the samples of the coding tree blocks. In a monochrome picture or a picture that has three separate color planes, a CTU may comprise a single coding tree block and syntax structures used to code the samples of the coding tree block. A coding tree block may be an N×N block of samples. A video frame or picture may be partitioned into one or more slices. A slice includes a number of consecutive treeblocks in a coding order (e.g., a raster scan order).

Each treeblock may be split into one or more coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, the CU is referred to as a leaf-CU.

Video encoder 20 may recursively perform quad-tree partitioning on the coding tree blocks of a CTU to divide the coding tree blocks into coding blocks, hence the name “coding tree units.” A coding block may be an N×N block of samples. In some examples, a CU comprises a coding block of luma samples and two corresponding coding blocks of chroma samples of a picture that has a luma sample array, a Cb sample array and a Cr sample array, and syntax structures used to code the samples of the coding blocks. In a monochrome picture or a picture that has three separate color planes, a CU may comprise a single coding block and syntax structures used to code the samples of the coding block.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, which may further include one or more prediction units (PUs), or transform units (TUs), in the context of HEVC, or similar data structures in the context of other standards (e.g., macroblocks and sub-blocks thereof in H.264/AVC).

A CU includes one or more prediction units (PUs) and one or more transform units (TUs). A size of the CU corresponds may be square or rectangular in shape. The size of the CU may range from 8×8 pixels up to the size of the treeblock with a maximum of 64×64 pixels or greater. Syntax data associated with a CU may describe, for example, partitioning of the CU into one or more PUs. Partitioning modes may differ between whether the CU is skip or direct mode encoded, intra-prediction mode encoded, or inter-prediction mode encoded. A CU may be partitioned such that PUs of the CU may be non-square in shape. Syntax data associated with a CU may also describe, for example, partitioning of the CU into one or more TUs according to a quadtree.

Video encoder 20 may partition a coding block of a CU into one or more prediction blocks. A prediction block may be a rectangular (i.e., square or non-square) block of samples on which the same prediction is applied. A PU of a CU may comprise a prediction block of luma samples, two corresponding prediction blocks of chroma samples of a picture, and syntax structures used to predict the prediction block samples. In a monochrome picture or a picture that has three separate color planes, a PU may comprise a single prediction block and syntax structures used to predict the prediction block samples.

A transform block may be a rectangular block of samples on which the same transform is applied. A transform unit (TU) of a CU may comprise a transform block of luma samples, two corresponding transform blocks of chroma samples, and syntax structures used to transform the transform block samples. Thus, each TU of a CU may have a luma transform block, a Cb transform block, and a Cr transform block. The luma transform block of the TU may be a sub-block of the CU's luma residual block. The Cb transform block may be a sub-block of the CU's Cb residual block. The Cr transform block may be a sub-block of the CU's Cr residual block. In a monochrome picture or a picture that has three separate color planes, a TU may comprise a single transform block and syntax structures used to transform the transform block samples. A TU can be square or non-square (e.g., rectangular) in shape. In other words, a transform block corresponding to a TU may be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU represents a spatial area corresponding to all or a portion of the corresponding CU, and may include data for retrieving a reference sample for the PU. Moreover, a PU includes data related to prediction. In some examples, a PU may be encoded using intra mode or inter mode. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

As indicated above, a leaf-CU having one or more PUs may also include one or more TUs. The TUs may be specified using an RQT (also referred to as a TU quadtree structure), as discussed above. For example, a split flag may indicate whether a leaf-CU is split into four transform units. Then, each TU may be split further into further sub-TUs. When a TU is not split further it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as RQTs. That is, a leaf-CU may include a quadtree indicating how the leaf-CU is partitioned into TUs. The root node of a TU quadtree generally corresponds to a leaf-CU, while the root node of a CU quadtree generally corresponds to a treeblock. TUs of the RQT that are not split are referred to as leaf-TUs. In general, this disclosure uses the terms CU and TU to refer to leaf-CU and leaf-TU, respectively, unless noted otherwise.

Both PUs and TUs may contain (i.e., correspond to) one or more blocks of samples corresponding to each of the channels of the color space associated with that block. Blocks of the PUs may include samples of a predictive block, and blocks of the TUs may blocks that include residual samples corresponding to the difference between the original block and the predictive block. For blocks associated with a YCbCr color space, blocks of luma samples may correspond to the “Y” channel, and two different channels of chroma blocks may correspond to the Cb and Cr channels, respectively.

As an example, HEVC supports prediction in various PU sizes. Assuming that the size of a particular CU is 2N×2N, HEVC supports intra-prediction in PU sizes of 2N×2N or N×N, and inter-prediction in symmetric PU sizes of 2N×2N, 2N×N, N×2N, or N×N. HEVC also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block has 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 or video decoder 30 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 or video decoder 30 may form the TUs including the residual data for the CU, and then transform the TUs to produce transform coefficients for the CU. In other words, video encoder 20 may apply a transform to a transform block for a TU to generate a transform coefficient block for the TU. Video decoder 30 may apply an inverse transform to the transform coefficient block for the TU to reconstruct the transform block for the TU.

Following application of transforms (if any) to produce transform coefficients, video encoder 20 or video decoder 30 may perform quantization of the transform coefficients. In other words, video encoder 20 may quantize the transform coefficients of a transform coefficient block. Video decoder 30 may dequantize the transform coefficients of the transform coefficient block. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m. Inverse quantization (i.e., dequantization) may increase the bit depths of some or all of the coefficients.

Following quantization, video encoder 20 may scan the transform coefficients, producing a one-dimensional vector from a two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 or video decoder 30 may utilize a predefined scan order to scan the quantized transform coefficients to produce a serialized vector that can be entropy encoded. In other examples, video encoder 20 or video decoder 30 may perform an adaptive scan. After scanning the quantized transform coefficients to form a one-dimensional vector, video encoder 20 or video decoder 30 may entropy encode the one-dimensional vector, e.g., according to context-adaptive binary arithmetic coding (CABAC), context-adaptive variable length coding (CAVLC), syntax-based context-adaptive binary arithmetic coding (SBAC), Probability Interval Partitioning Entropy (PIPE) coding or another entropy coding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in variable length coding (VLC) may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

One or more of the techniques of this disclosure are directed toward techniques for transforming video data from a first color space to a second color space. Accordingly, video encoder 20 represents an example of a video coder configured to determine a cost associated with a plurality of color transforms associated with a coding unit, select a color transform of the plurality of color transforms having a lowest associated cost, transform a first block of video data having a first, Red, Green, Blue (RGB) color space to produce a second block of video data having a second color space using the selected color transform of the plurality of color transforms, and encode the second video block having the second color space.

Video decoder 30 represents an example of a video coder configured to receive syntax data associated with a coded unit in a bitstream, the syntax data indicative of one of a plurality of inverse color transforms, select an inverse color transform of the plurality of inverse color transforms based on the received syntax data, inversely transform a first block of video data having a first color space to a second block of video having a second, red, green, blue (RGB) color space using the selected inverse color transform of the plurality of inverse color transforms, and decode the second video block having the second, RGB color space

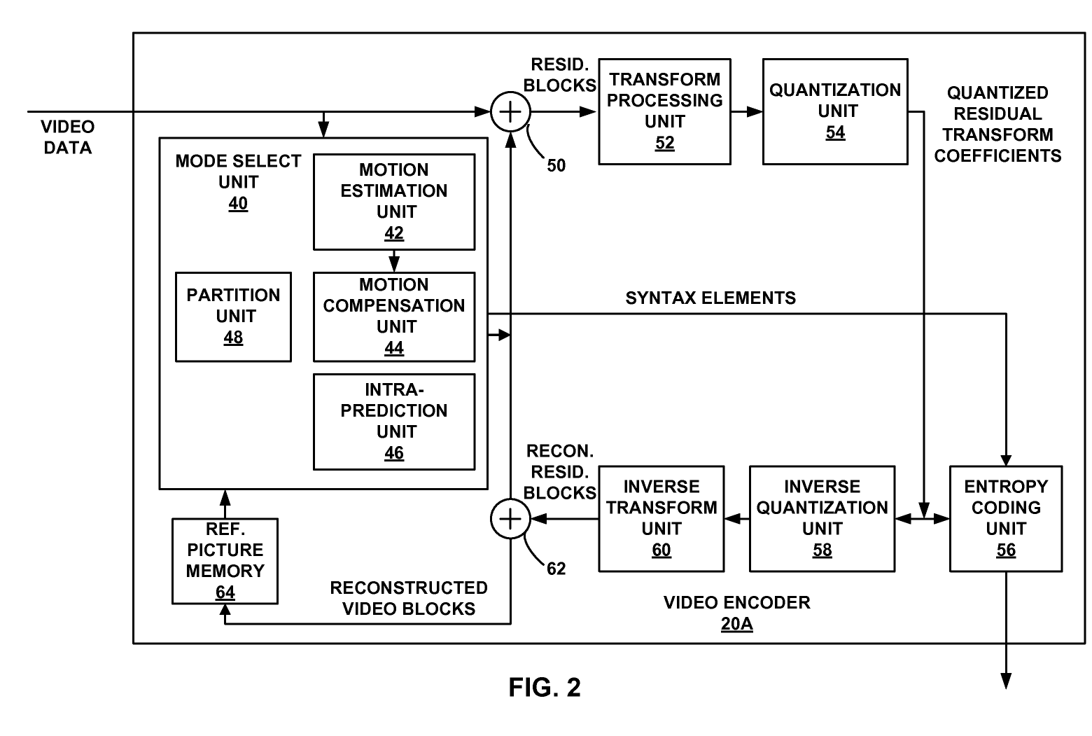

FIG. 2 is a block diagram illustrating an example video encoder 20A that may implement techniques for transforming blocks of video data having a first RGB color space to video data having a second color space using a color transform in accordance with one or more aspects of this disclosure. In the example of FIG. 2, video encoder 20A may perform intra- and inter-coding of video blocks within video slices. In some examples, video encoder 20A may be an example of video encoder 20 of FIG. 1. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

In the example of FIG. 2, video encoder 20A includes mode select unit 40, reference picture memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20A also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20A receives a video frame or slice to be coded. The frame or slice may be divided into multiple video blocks. In this way, video encoder 20A may receive a current video block within a video frame to be encoded. In various examples, the video frame or slice may have an RGB color space. In some examples, video encoder 20A may be configured to transform the RGB video data, referred to as an “original signal,” to blocks of a second color space, using a color space transform, as described in greater detail below. In this example, video encoder 20A performs the transform prior to motion inter- or intra-prediction.

Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Intra-prediction unit 46 and/or motion compensation unit 44 may be configured to transform predictive and/or residual blocks of RGB video data (i.e. after intra- or inter-prediction has been performed) to a second color space using a transform. The predictive and residual blocks may both be referred to as a “residual signal.” Video encoder 20A may perform multiple coding passes, e.g., to select an appropriate coding mode for each block of video data.

Summer 50 may form a residual video block by determining differences between pixel values of the predictive block from the pixel values of the current video block being coded. In some examples, summer 50 may determine not determine or encode a residual block.

Partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and may provide the resulting intra- or inter-coded block to summer 50. Summer 50 may generate residual block data. For instance, summer 50 may generate residual block data for a current CU such that each sample of the residual block data is equal to a difference between a sample in a coding block of the current CU and a corresponding sample of a prediction block of a PU of the current CU. Summer 62 may reconstruct the encoded block (i.e., the coding block) for use as a reference frame. Mode select unit 40 also provides syntax elements, such as motion vectors, intra-mode indicators, partition information, and other such syntax information, to entropy encoding unit 56.

In various examples in accordance with one or more of the techniques of this disclosure, mode select unit 40 may be configured to select one transform to a second color space out of more than one color transform such that the selected color transform optimizes a rate-distortion cost function, such as a Lagrangian cost function. Mode select unit, or another unit of video encoder 20A, such as entropy coding unit 56, may encode a syntax element, such as index value, in a coded video bitstream. The encoded index value may indicate the selected color transform that optimizes the Lagrangian cost function.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). In other words, a motion vector may indicate a displacement between a prediction block of a PU and a corresponding predictive block in a reference picture. A predictive block is a block that is found to closely match the block to be coded (i.e., the prediction block), in terms of pixel difference, which may be determined by sum of absolute difference (SAD), sum of square difference (SSD), or other difference metrics.

In some examples, video encoder 20A may calculate values for sub-integer pixel positions of reference pictures stored in reference picture memory 64. In other words, video encoder 20A may use apply one or more interpolation filters to samples of one or more reference pictures to generate samples in a predictive block of a PU. In some examples, video encoder 20A may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 may calculate a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. If motion estimation unit 42 has calculated a motion vector, motion estimation unit 42 may send the calculated motion vector to entropy encoding unit 56 and motion compensation unit 44.

Motion compensation unit 44 may perform motion compensation. Motion compensation may involve fetching or generating one or more predictive blocks for a PU based on the one or more motion vectors determined for the PU by motion estimation unit 42. Again, motion estimation unit 42 and motion compensation unit 44 may be functionally integrated in some examples. Upon receiving a motion vector for a PU of a current video block, motion compensation unit 44 may locate a predictive block from a picture of one of the reference picture lists based on the motion vector. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and may select the intra-prediction mode having the best rate-distortion characteristics among the tested intra-prediction modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20A may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20A may form a residual video block by determining differences between prediction data (e.g., a predictive block) from mode select unit 40 and data from an original video block (e.g., a coding block) being coded. Summer 50 represents the component or components that perform this difference operation. Transform processing unit 52 may apply a transform to the residual block, producing a video block (i.e., a transform coefficient block) comprising residual transform coefficient values. For example, transform processing unit 52 may apply a discrete cosine transform (DCT) or a conceptually similar transform to produce the residual coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. In other words, entropy encoding unit 56 may entropy encode syntax elements representing the quantized transform coefficients. For example, entropy encoding unit 56 may perform context adaptive binary arithmetic coding (CABAC), context adaptive variable length coding (CAVLC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. For instance, inverse quantization unit 58 may dequantize a transform coefficient block. Inverse transform unit 60 may reconstruct a transform block for a TU by applying an inverse transform to the dequantized transform coefficient block. Summer 62 adds the reconstructed residual block to the motion compensated prediction block produced by motion compensation unit 44 to produce a reconstructed video block for storage in reference picture memory 64. Motion estimation unit 42 and motion compensation unit 44 may use the reconstructed video block as a reference block to inter-code (i.e., inter predict) a block in a subsequent video frame. Motion compensation unit 44 may also apply one or more interpolation filters to the reconstructed residual block to calculate sub-integer pixel values for use in motion estimation.

Motion estimation unit 42 may determine one or more reference pictures, that video encoder 20A may use to predict the pixel values of one or more. For PUs that are inter-predicted. Motion estimation unit 42 may signal each reference picture as an LTRP or a short-term reference picture. Motion estimation unit 42 may store the reference pictures in a decoded picture buffer (DPB) (e.g., reference picture memory 64) until the pictures are marked as unused for reference. Mode select unit 40 of video encoder 20A may encode various syntax elements that include identifying information for one or more reference pictures.

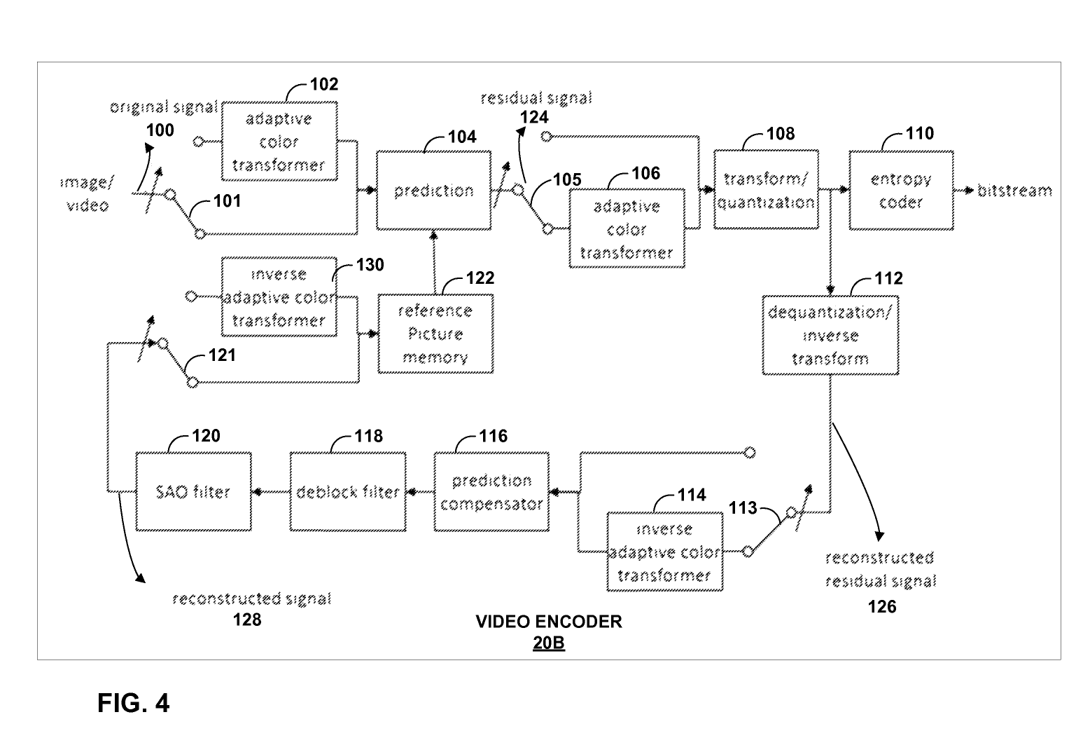

In addition to the various units illustrated in FIG. 2, video encoder 20A may further include one or more color space transformer units and/or adaptive color space transformer units, which may perform a color transform or an inverse color transform. The adaptive color space transformer units may be located in between various units illustrated in FIG. 2. e.g. before mode select unit 40, and/or after quantization unit 54. The location of adaptive color space transformer units in video encoder 20A is described in greater detail below with respect to the example of FIG. 4.

In this manner, video encoder 20A in FIG. 2 represents an example of a video encoder configured to determine a cost associated with a plurality of color transforms associated with a coding unit. Video encoder 20A may be further configured to select a color transform of the plurality of color transforms having a lowest associated cost, transform a first block of video data having a first, Red, Green, Blue (RGB) color space to produce a second block of video data having a second color space using the selected color transform of the plurality of color transforms, and encode the second video block having the second color space.

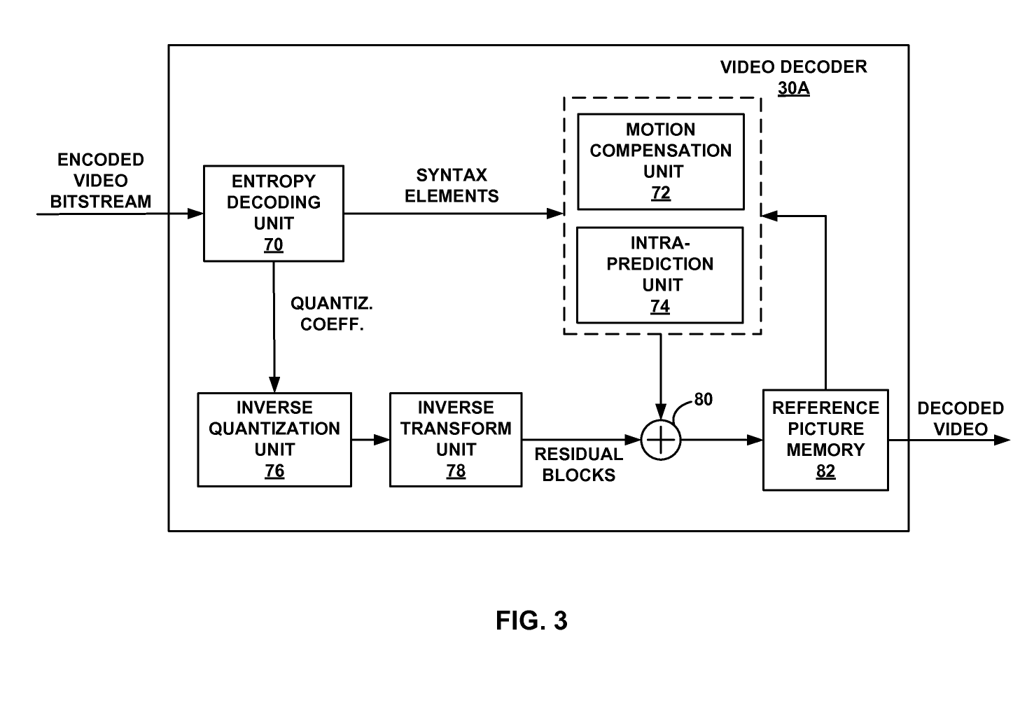

FIG. 3 is a block diagram illustrating an example of a video decoder that may implement techniques for transforming video data having a first color space to video data having a second, RGB color space using a color transform in accordance with one or more aspects of this disclosure. In the example of FIG. 3, video decoder 30A includes an entropy decoding unit 70, motion compensation unit 72, intra-prediction unit 74, inverse quantization unit 76, inverse transformation unit 78, reference picture memory 82 and summer 80. Video decoder 30A may be an example of video decoder 30 of FIG. 1. In some examples, video decoder 30A may perform a decoding pass generally reciprocal to the encoding pass described with respect to video encoder 20A (FIG. 2).

During the decoding process, video decoder 30A receives an encoded video bitstream that represents video blocks of an encoded video slice and associated syntax elements and/or syntax data from video encoder 20A. Entropy decoding unit 70 of video decoder 30A entropy decodes the bitstream to generate quantized coefficients, motion vectors or intra-prediction mode indicators, and other syntax elements. Entropy decoding unit 70 may forward the motion vectors to and other syntax elements to motion compensation unit 72.

Entropy decoding unit 70 may receive syntax data for a CU that is indicative of one of a plurality of inverse color transforms. Video decoder 30A may select an inverse transform for a block or the coded unit based on the syntax data. In some examples, the syntax data may comprise a an index value syntax element. The index value may indicate that the selected color transforms is a color transform of the one or more color transforms that minimizes a Lagrangian cost function described above. In some examples, the index value may indicate a selected inverse color transform of the plurality of inverse color transforms that has a lowest associated distortion cost.

In some examples, the index syntax element may indicate a selected inverse color transform of the plurality of inverse color transforms that is associated with a color space having a highest associated correlation between color components of the RGB color space and each of a plurality of color components associated with each of the plurality of color transforms. In some examples, the syntax data may be syntax data of one or more neighboring reconstructed blocks relative to the current CU or current block (e.g., indicating inverse transforms applied to those blocks). Video decoder 30A may determine the highest correlation based on the syntax elements of the reconstructed neighboring blocks relative to at least one of the first block and the second block in some examples. Video decoder 30A may receive the syntax elements at the video slice level and/or the video block level, as well as at other levels.

Video decoder 30A may construct reference picture lists, List 0 and List 1, (e.g., using default construction techniques) based on reference pictures stored in reference picture memory 82. When the video slice is coded as an intra-coded (I) slice, intra-prediction unit 74 may generate prediction data for a video block of a current video slice. Intra-prediction unit 74 may generate the prediction data based on a signaled intra prediction mode and data from previously decoded blocks of the current frame or picture. When video decoder 30A codes slices of the video frame as an inter-coded (i.e., B, P or GPB) slice, motion compensation unit 72 may produce predictive blocks for a video block of the current video slice based on the motion vectors and other syntax elements received from entropy decoding unit 70. Motion compensation unit 72 may produce the predictive blocks from one of the reference pictures within one of the reference picture lists.

Motion compensation unit 72 may use motion vectors and/or syntax elements to predict determine prediction information for a video block of the current video slice. In some examples, motion compensation unit 72 may generate prediction information based on motion vectors received from entropy decoding unit 70. Motion compensation unit 72 may use the prediction information to produce the predictive blocks for the current video block being decoded. For example, motion compensation unit 72 uses some of the received syntax elements to determine a prediction mode (e.g., intra- or inter-prediction) used to code the video blocks of the current video slice, an inter-prediction slice type (e.g., B slice, P slice, or GPB slice), construction information for one or more of the reference picture lists for the slice, motion vectors for each inter-encoded video block of the current video slice, inter-prediction status for each inter-coded video block of the slice, and other information to decode the video blocks in the current video slice.

When a motion vector of a PU has sub-pixel accuracy, motion compensation unit 72 may apply one or more interpolation filters to samples of a reference picture to generate a predictive block for the PU. In other words, motion compensation unit 72 may also perform interpolation based on interpolation filters. Motion compensation unit 72 may calculate interpolated values for sub-integer pixels of reference blocks using the same interpolation filters video encoder 20 used during encoding of the video blocks. Thus, in some examples, motion compensation unit 72 may determine the interpolation filters used by video encoder 20 from the received syntax elements and may use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} to determine a degree of quantization and, likewise, a degree of inverse quantization that should be applied. Video decoder 30A may calculate the quantization parameter QP_{Y} for each video block in the video slice.

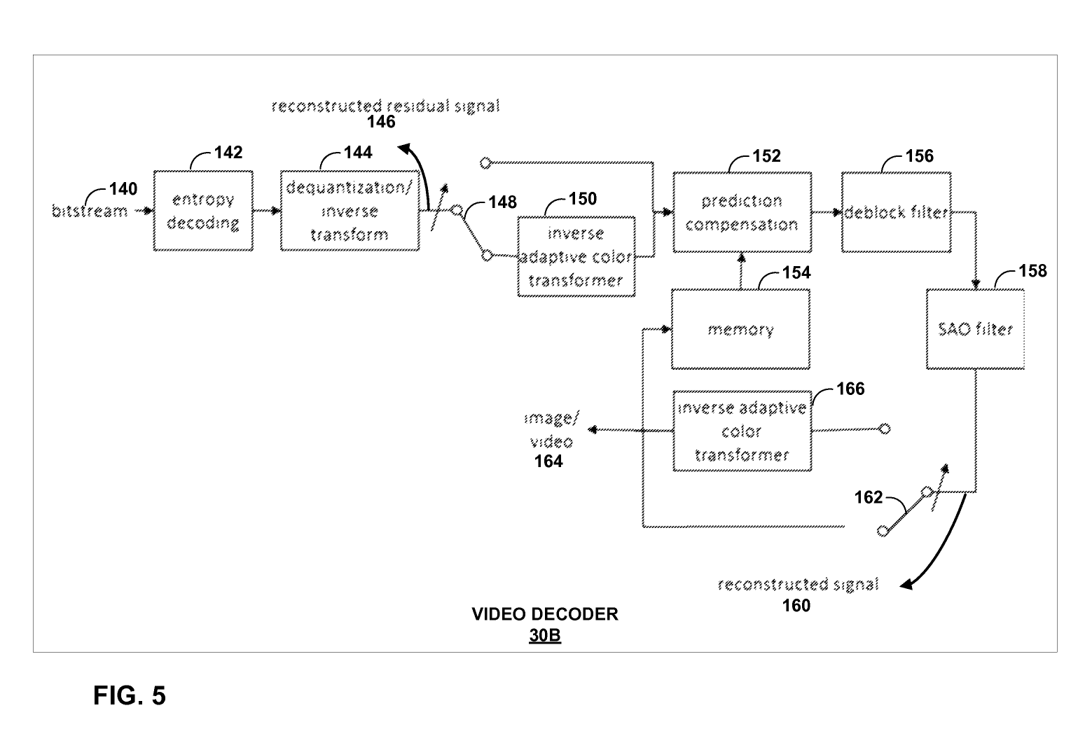

Inverse transform unit 78 may receive dequantized transform coefficient blocks. If transform is skipped for the current block, inverse transform unit 78 may receive dequantized residual blocks. Inverse transform unit 78 may transform the received blocks using an inverse transform. In some examples, the inverse transform (e.g., an inverse DCT, an inverse integer transform, or a conceptually similar inverse transform process) to the transform coefficients in order to produce residual blocks (e.g., transform blocks) in the pixel domain. Inverse transform unit 78 may output a signal, referred to as a “reconstructed residual signal.” In some examples, inverse transform unit 78 or an inverse adaptive color transformer (illustrated in greater detail in the example of FIG. 5) may inversely transform the transform coefficient and/or residual blocks from a first color space to blocks of a second space using an inverse color transform in accordance with the techniques of this disclosure.

Video decoder 30A may also determine that the current block is intra-predicted based on syntax elements or other information. If the current video block is intra-predicted, intra-prediction unit 74 may decode the current block. Intra-prediction unit 74 may determine a neighboring predictive block from the same picture as the current block. Intra-prediction unit 74 may generate a transform coefficient block and/or a residual block based on the predictive block.

After motion compensation unit 72 or intra-prediction unit 74 generates a transform coefficient block and/or residual block for a current video block based on the motion vectors and other syntax elements, video decoder 30A forms a decoded video block by combining the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. Reference picture memory 82 stores the decoded video blocks in a given frame or picture, which video decoder 30 may use for subsequent motion compensation. Reference picture memory 82 may also store decoded video for later presentation on a display device, such as display device 32 of FIG. 1.

Once video decoder 30 generates reconstructed video, video decoder 30 may output the reconstructed video blocks as decoded video (e.g., for display or storage) in some examples. In other examples, video decoder 30 may be further configured to transform blocks of the reconstructed video data, referred to as a “reconstructed signal,” from a first color space to a second RGB color space using an inverse color transform.

As described above, during inter-prediction, motion compensation unit 72 may determine one or more reference pictures that video decoder 30A may use to form the predictive video blocks for the current block being decoded. Motion compensation unit 72 may determine whether reference pictures are long term reference pictures or short-term reference pictures based on syntax elements of the coded video bitstream, which indicate whether a reference picture is marked for long term reference or short-term reference. Motion compensation unit 72 may store the reference pictures in a decoded picture buffer (DPB) (e.g., reference picture memory 82) until the reference pictures are marked as unused for reference.

Motion compensation unit 72 of video decoder 30A may decode various syntax elements that include identifying information for one or more reference pictures used to form predictive blocks for the currently decoding block. During the decoding of an inter-predicted PU, motion compensation unit 72 may decode identifying information of one or more LTRPs for the current picture which are signaled in the active sequence parameter set. Motion compensation unit 72 may also decode identifying information for one or more short-term reference pictures used for predicting the current picture in the slice header of the current picture or the picture parameter set for the current picture.

In addition to the various units illustrated in FIG. 3, video decoder 30A may further include one or more color transformer units and/or adaptive color transformer units, which may perform a color transform or an inverse color transform. The adaptive color transform units may be located in between various units illustrated in FIG. 3, e.g. before entropy decoding unit 70, and/or after inverse transform unit 78. The location of adaptive color transformer units in video decoder 30A is described in greater detail below with respect to the example of FIG. 5.

In this manner, video decoder 30A in FIG. 3 represents an example of a video decoder configured to transform a first block of video data having a first color space to a second block of video data having a red, green, blue (RGB) color space using an inverse color transform of one or more inverse color transforms, and decode the second video block having the RGB color space.

In another example, video decoder 30A may represent an example of a video decoder configured to adaptively transform a first block of video data having a first color space to a second block of video data having a second color space using an inverse color transform of one or more inverse color transforms, wherein the second color space is a RGB color space, and decode the second video block having the RGB color space.

FIG. 4 is a block diagram illustrating another example video encoder 20B that may utilize techniques for transforming video data having an RGB color space to blocks of video data having a second color space using a color transform in accordance with one or more aspects of this disclosure.

FIG. 4 illustrates a more detailed version of video encoder 20A. Video encoder 20B may be an example of video encoder 20A (FIG. 2) or video encoder 20 (FIG. 1). The example of FIG. 4 illustrates two possible examples for implementing the techniques of this disclosure. In the first implementation, video encoder 20B adaptively transforms a first block of an input video signal having a first color space to a second block having a second color space using a color transform of one or more color transform. The second illustrated example performs the same techniques, but performs the color transformation on blocks of residual video data, rather than on an input signal.

In the example of FIG. 4, video encoder 20B is shown as performing color transforms on predictive and residual blocks of video data (i.e., an original signal) because of the way switches 101, 105, 113, 121 are currently switched. If switches 101, 105, 113, and 121 are switched the alternative position, video encoder 20B is configured to perform color transforms on blocks of video data of an original signal having an RGB color space to blocks of video data having a second color space before performing motion estimation, and motion prediction, rather than transforming blocks of predictive and/or residual video data.

The process of performing color transforms on blocks of residual video data as illustrated in FIG. 4 is now described in greater detail. In the example of FIG. 4, an original signal 100 is passed to prediction processing unit 104 (following the path of switch 101). Prediction processing unit 104 may receive data from one or more reference pictures from reference picture memory 122. Prediction processing unit 104 generates a predictive block of video data, and combines the predictive block of video data from the original signal 100 to generate residual signal 124. In this example, adaptive color transformer 106 transforms the predictive block and the residual block of video data from an RGB color space to a second predictive block and a second residual block of video having a second color space. In some examples, video encoder 20B may select the second color space and the color transform based on a cost function.

Transform/quantization unit 108 may perform a transform (e.g., a discrete cosine transformation) on the second video block having the second color space. In addition, transform/quantization unit 108 may quantize the second video block (i.e., the transformed residual video block). Entropy encoder 110 may entropy encode the quantized residual video block. Entropy encoder may output a bitstream that includes the quantized residual video block for decoding by a video decoder, e.g. video decoder 30.

Dequantization/inverse transform unit 112 may also receive the quantized, transformed coefficient and/or residual video blocks, and may inversely transform and dequantize the transformed coefficient and residual video blocks. The dequantized, inversely transformed video blocks may still have the second color space at this point. The result of the dequantization/inverse transform is reconstructed residual signal 126. Inverse adaptive color transformer 114 may inversely color transform the reconstructed residual signal based on the inverse color transform associated with the transform performed by adaptive color transformer 106. The resulting inversely adaptive color transformed coefficient and/or residual video blocks may have an RGB color space at this point.

Following application of an inverse color transformation to a residual video block, prediction compensator 116 may add back in a predictive block to the residual video block. Deblock filter 118 may deblock the resulting block. SAO filter 120 may perform SAO filtering. Reference picture memory 122 may then store the resulting reconstructed signal 128 for future use.

To color transform a video block of an input signal (i.e., unencoded video data), rather than a block of residual video data, switch 101 is flipped to the alternate position, and adaptive transformer 102 color transforms the input video block from a video block having an RGB color space to a second color space using a color transform of the one or more color transforms. Prediction with prediction processing unit 104 proceeds as described above, but the result may be fed to transform/quantization unit 108 directly because switch 105 is in the alternate position (as compared to the position illustrated in FIG. 4), rather than being color transformed by adaptive color transformer 106.

Transformation/quantization unit 108, entropy coder 110, and dequantization/inverse transform unit 112 may each operate as described above with respect to color transforming a residual video block, and reconstructed signal 126 is generated, and is also in the second color space. Reconstructed signal 126 is fed to prediction compensator 116 via switch 113. Switch 113 is in the alternate position to the position illustrated in FIG. 4, and inverse adaptive color transformer 114 is bypassed. Prediction compensator 116, deblock filter 118, and SAO filter 120 may operate as described above with respect to color transforming a residual video block to produce reconstructed signal 128. However, unlike reconstructed signal 128 described above, in this example, a block of reconstructed signal 128 may still have the second color space, rather than the RGB color space.

Reconstructed signal 128 may be fed to inverse adaptive color transformer 130 via switch 121, which is in the alternate position to that illustrated in FIG. 4. Inverse adaptive color transformer 130 may inversely color transform blocks of reconstructed signal 128 to blocks having an RGB color space, and reference picture memory 122 may store the blocks as blocks of a reference picture for future reference.

As described above, video encoder 20B may select a transform of the one or more color spaces to transform a first block of the video data having an RGB color space, to a second color space. In some examples, video encoder 20B selects the color transform adaptively by calculating rate-distortion costs associated with each of the color transforms. For instance, video encoder 20B may select the color transform of the plurality of color transforms that has the lowest associated distortion cost for a CU or block of a CU. Video encoder 20B may signal an index syntax element or other syntax data that indicates the selected color transform that has the lowest associated distortion cost.

In some examples, video encoder 20B may utilize a Lagrangian cost function that accounts for the tradeoff between the bitrate (e.g. the compression achieved) by the color transform, as well as the distortion associated with the color transform. In some examples, the Lagrangian cost corresponds to L=D+λR, where L is the Lagrangian cost, D is the distortion, λ is a Lagrange multiplier, and R is the bitrate. In some examples, video encoder 20B may signal an index syntax element that indicates the color transform of the plurality of color transforms that minimizes the Lagrangian cost.

In some high performance or high fidelity video coding applications or configurations, distortion should be minimized above minimizing bitrate. In such cases, when transforming video data from an RGB color space to a second color space, video encoder 20B may select the color transform, and the color space that results in the least distortion. Video encoder 20B may signal an index syntax element that indicates the selected color transform or color space that results in the least distortion.

In some other cases, video encoder 20B may calculate a cost of transforming blocks of an RGB color space to a second color space based on the correlation between each of the color components of the block of RGB video data and the color components of the block of the second color space. The color transform having the lowest associated cost may be the color transform that has color components that are most closely correlated with the RGB color components of the input signal. Video encoder 20B may signal an index syntax element that indicates the selected color transform that has the highest correlation between its color components and RGB color components.

It should be recognized that in some cases, video encoder 20B may select different color transforms for different CUs, LCUs. CTUs, etc. That is, for a single picture, video encoder 20B may select different color transforms associated with different color spaces. Selecting multiple different color transforms may better optimize coding efficiency and reduce rate distortion. To indicate which transform of the multiple transforms that video encoder 20B has selected for the current block, video encoder 20B may signal an index value corresponding to the selected color transform. Video encoder 20B may signal the index value at one or more of the first block of video a CTU, CU, PU, and a TU.

However, in some cases, video encoder 20B may determine a single color transform that is to be applied to one or a plurality of blocks, or a sequence of coded pictures, referred to as a CVS. In the case that only one color transform is selected, for each block, video encoder 20B may signal a flag syntax element. One value of the flag syntax element may indicate that video encoder 20B has applied the single transform to the current block or to all of the pictures in the CVS. The other value of the flag syntax element indicates that no transform has been applied to the current block. Video encoder 20B may determine whether or not to apply the color transform to each of the blocks of the picture on an individual basis, e.g. using the cost-based criteria described above.

In some examples, video encoder 20B determine whether to apply a pre-defined color transform of the plurality of inverse color transforms to each one of the plurality of blocks. For example, video encoder 20B and video decoder 30B may utilize a default pre-defined color transform/inverse color transform. Responsive to determining to apply the pre-defined color transform to each one of the plurality of blocks, video encoder 20B may transform each of the plurality of blocks using the pre-defined color transform without decoding data indicating that the pre-defined color transform has been applied to each one of the plurality blocks of video data.

In a reciprocal manner, video decoder 30B may be configured to determine whether to apply a pre-defined inverse color transform of the plurality of inverse color transforms to each one of the plurality of blocks. Responsive to determining to apply the pre-defined inverse color transform to each one of the plurality of blocks, video decoder 30B may inversely transform each of the plurality of blocks using the pre-defined color transform without decoding data indicating that the pre-defined color transform has been applied to each one of the plurality blocks of video data.

The color transforms of this disclosure may include, but are not necessarily limited to, an identity transform, a differential transform, a weighted differential transform, a DCT, a YCbCr transform, a YCgCo transform, and a YCgCo—R transform to the block of video data. A video coder configured in accordance with the techniques of this disclosure, such as video encoder 20B, may apply one or more of these transforms and/or their inverses as well as other transforms, such as transforms to/from Adobe RGB, sRGB, scRGB, Rec. 709, Rec. 2020, Adobe Wide Gamut RGB, ProPhoto RGB, CMYK, Pantone, YIQ, YDbDr, YPbPr, xvYCC, ITU BT.601, ITU BT.709, HSV, and other color spaces, color spaces, and/or chroma subsampling formats not specifically described herein.

To apply a color transform to a block of video data having an RGB color space, video encoder 20B may multiply a 3×1 matrix comprising the Red, Green, and Blue color components of an RGB pixel with a color transform matrix. The result of the multiplication is a pixel having a second color space. The video coder may apply the color transform matrix to each pixel of the video block to produce a second block of pixels in a second color space. Various color transforms are now described in greater detail.

In some examples, video encoder 20B may apply an identity transform matrix or inverse identity transform matrix. The identity transform matrix comprises:

$$[ \begin{matrix}1 & 0 & 0 \\ 0 & 1 & 0 \\ 0 & 0 & 1\end{matrix} ] ,$$

and the inverse transform matrix, which video decoder 30A may apply, comprises:

$$[ \begin{matrix}1 & 0 & 0 \\ 0 & 1 & 0 \\ 0 & 0 & 1\end{matrix} ] .$$

When a video coder applies the identity transform, the resulting pixel value is identical to the input pixel value, i.e. applying the identity transform is equivalent to not applying a color transform at all. Video encoder 20B may select the identity transform when maintaining the RGB color space of the video blocks is required.

In another example, video encoder 20B may apply a differential transform matrix. The differential transform matrix comprises:

$$[ \begin{matrix}0 & 1 & 0 \\ 0 & - 1 & 1 \\ 1 & - 1 & 0\end{matrix} ] .$$

Video decoder 30A may apply a reciprocal, inverse differential matrix, which comprises:

$$[ \begin{matrix}1 & 0 & 1 \\ 1 & 0 & 0 \\ 1 & 1 & 0\end{matrix} ] .$$

In another example, video encoder 20B may be configured apply a weighted differential transform or inverse weighted differential transform. The weighted differential transform matrix comprises:

$$[ \begin{matrix}0 & 1 & 0 \\ 0 & - {α}_{1} & 1 \\ 1 & - {α}_{2} & 0\end{matrix} ] ,$$

and the inverse, weighted differential matrix, which video decoder 30B may apply, comprises:

$$[ \begin{matrix}{α}_{2} & 0 & 1 \\ 1 & 0 & 0 \\ {α}_{1} & 1 & 0\end{matrix} ] .$$

In the weighted differential transforms, α₁ and α₂ are parameters that a video coder may adjust. In some examples, video encoder 20A may calculate the parameters α₁ and α₂ according to the following equations:

α₁=cov(G,B)/var(G), and

α₂=cov(G,R)/var(G).

Video encoder 20B may signal the values of α₁ and α₂ in the coded video bitstream in various examples.

In these equations, R corresponds to a red color channel. G corresponds to a green color channel, and B corresponds to a blue color channel of the RGB color space. In the differential transform equations. “cov( )” is the covariance function, and “var( )” is the variance function.

To determine the values of R, G, and B, an encoder or decoder may utilize a set of reference pixels in order to ensure that the covariance and variance functions have the same result or weight when calculated by the encoder or by the decoder. In some examples, the particular reference pixels may be signaled in the coded video bitstream (e.g. as syntax elements in a coded video bitstream). In other examples, the encoder and decoder may be preprogrammed to use certain reference pixels.

In some examples, video encoder 20B may restrict or constrain the values of α₁ and α₂ when transforming blocks using the differential transform. The video coder may constrain the values of α₁ and α₂ to a set of integers or dyadic numbers, e.g. ½, ¼, ⅛, etc. . . . . In other examples, a video coder may restrict α₁ and α₂ to values of a fraction having a dyadic number. e.g. ⅛, 2/8, ⅜, . . . , 8/8. A dyadic number or dyadic fraction is a rational number having a denominator that is a power of two, and where the numerator is an integer. Restricting the values of α₁ and α₂ may improve the bitstream efficiency of coding α₁ and α₂.

In other examples, video encoder 20B may be configured to transform a block having an RGB color space to generate a second block, using a DCT transform. The DCT transforms samples of a block to express the samples as a sum of sinusoids of different frequencies and amplitudes. A DCT transform or inverse transform may transform pixel to and from a finite sequence of data points in terms of a sum of cosine functions. The DCT transform matrix corresponds to:

$$[ \begin{matrix}0.5774 & 0.5774 & 0.5774 \\ 0.7071 & 0 & - 0.7071 \\ 0.4082 & - 0.8156 & 0.4082\end{matrix} ] .$$

In a reciprocal manner, video decoder 30B may be configured to apply an inverse transform to blocks transformed using the DCT revert the blocks back to the original samples. The inverse DCT transform matrix corresponds to:

$$[ \begin{matrix}0.5774 & 0.7071 & 0.4082 \\ 0.5774 & 0 & - 0.8156 \\ 0.5774 & - 0.7071 & 0.4082\end{matrix} ] .$$

Video encoder 20B may also apply a YCbCr transform to a block having an RGB color space to produce a block having a YCbCr color space. As described above, the YCbCr color space includes a luma (Y) component, as well as blue chrominance (Cb) and red chrominance (Cr) components. The YCbCr transform matrix may correspond to:

$$[ \begin{matrix}0.2126 & 0.7152 & 0.0722 \\ - 0.1172 & - 0.3942 & 0.5114 \\ 0.5114 & - 0.4645 & - 0.0469\end{matrix} ] .$$

Video decoder 30B may be configured to apply an inverse YCbCr transform to convert a block having a YCbCbr color space to a block having an RGB color space. The inverse YCbCr transform matrix may correspond to:

$$[ \begin{matrix}1 & 0 & 1.5397 \\ 1 & - 0.1831 & - 0.4577 \\ 1 & 1.8142 & 0\end{matrix} ] .$$

Video encoder 20B may also apply a YCgCo transform to a block having an RGB color space to produce a block having a YCgCo color space. A YCgCo color space includes a luma (Y) component, as well as green chrominance (Cg) and orange chrominance (Co) components. The YCgCo transform matrix may correspond to:

$$[ \begin{matrix}0.2126 & 0.7152 & 0.0722 \\ - 0.1172 & - 0.3942 & 0.5114 \\ 0.5114 & - 0.4645 & - 0.0469\end{matrix} ] .$$

Video decoder 30B may be configured to apply an inverse YCgCo transform to convert a block having a YCgCo color space to a block having an RGB color space. The inverse YCgCo transform matrix may correspond to:

$$[ \begin{matrix}1 & 0 & 1.5397 \\ 1 & - 0.1831 & - 0.4577 \\ 1 & 1.8142 & 0\end{matrix} ] .$$

Video encoder 20B may also be configured to apply a YCgCo—R transform to a block having an RGB color space to produce a block having a YCgCo—R color space. The YCgCo—R color space includes a luma (Y) component, as well as green chrominance (Cg) and orange chrominance (Co) components. Unlike the YCgCo transform described above, however, the YCgCg-R transform is reversible, e.g. the YCgCo—R transform may not produce any distortion, for example due to rounding errors.

The YCbCr transform matrix may correspond to:

Co=R−B

t=B+└Co/2┘

Cg=G−t

Y=t+└Cg/2┘.

Video decoder 30B may be configured to apply an inverse YCgCo—R transform. The YCgCo—R inverse transform inversely transforms blocks having a YCgCo—R color space to blocks having an RGB color space. The inverse YCgCo—R transform matrix may correspond to:

t=Y−└Cg/2┘

G=Cg+t

B=t−└Co/2┘

R=B+Co.

To apply any of the color transforms described herein, video encoder 20B may implement a lifting scheme that has flexible parameters. A lifting scheme is a technique of decomposing a discrete wavelet transform into a finite sequence of simple filtering steps, referred to as lifting steps or as ladder structures. Video encoder 20B may signal the parameters in the coded video bitstream, or video encoder 20B may derive the parameters may be derive the parameters the same way. One example of a lifting scheme is as follows:

R′=R+└aB┘

B′=B+└bR′┘

G′=G+└cB′┘

R″=R′+└dG′┘,

where a, b, c, and d are parameters as described above. In this lifting scheme, R, G, and B are red, green, and blue color channels or samples, respectively. As with the α parameters described above with respect to the weighted differential transform, the values of a, b, c, and d may be restricted or limited, e.g. so the signs can only be positive or negative. In some cases, there may be additional steps in the lifting scheme, such as:

R′″=└eR″+f┘

B″=└gB′+h┘,

G″=└iG′+j┘

where f, g, h, i, and j are parameters. When using the lifting scheme, as well as in other examples, the video encoder 20A and video decoder 30A can normalize the output depth of the three components, R′″, B″, and G″ can be normalized within a pre-determined bit depth, which may not necessarily be the same for each component.

In this manner, video encoder 20B of FIG. 4 represents a video encoder configured to determine a cost associated with a plurality of color transforms associated with a coding unit, and select a color transform of the plurality of color transforms having a lowest associated cost, transform a first block of video data having a first, Red, Green, Blue (RGB) color space to produce a second block of video data having a second color space using the selected color transform of the plurality of color transforms, and encode the second video block having the second color space.

FIG. 5 is a block diagram illustrating another example video decoder 30B that may utilize techniques for inversely transforming video data having a first color space to video data having a second, RGB color space using an inverse color transform in accordance with one or more aspects of this disclosure.

FIG. 5 illustrates a more detailed version of video decoder 30B. In some examples video decoder 30B may be an example of video decoder 30A (FIG. 2) and/or video decoder 30 (FIG. 1). The example of FIG. 5 illustrates two possible examples for implementing the techniques of this disclosure. In the first implementation, video decoder 30B adaptively inversely transforms a block of an input video signal from a first color space (e.g., a non-RGB color space) to a second block having a second, RGB color space using an inverse color transform of a plurality of inverse color transforms. The second illustrated example performs the same techniques, but performs the inverse color transformation on blocks of residual video data, rather than on an input signal.

In the example of FIG. 5, video decoder 30B is shown as performing inverse color transforms on blocks of residual video data example because of the way switches 145, and 156 are currently switched. If switches 145 and 156 are switched the alternative position, video decoder 30B is configured to inversely color transform blocks of input video data having a first representation to a blocks of video data having a second, RGB color space, rather than inversely transforming blocks of residual video data.

The process of performing inverse color transforms on blocks of residual video data as illustrated in FIG. 5 is now described in detail. In the example of FIG. 5, an encoded input bitstream 140 (also referred to as an input signal) is passed to entropy decoding unit 142. Entropy decoding unit 142 may entropy decode bitstream 140 to produce a quantized block of residual video data having a first color space. For instance, entropy decoding unit 142 may entropy decode particular syntax elements included in bitstream 140. Dequantization/inverse transform unit 144 may dequantize a transform coefficient block. Additionally, dequantization/inverse transform unit 144 may apply an inverse transform to the transform coefficient block to determine a transform block comprising residual video data. Thus, dequantization/inverse transform unit 144 may dequantize and inversely transform blocks of entropy decoded video data of bitstream 140. When video decoder 30B is configured to inversely color transform blocks of residual data, switch 148 feeds a block of residual video data having a first color space to inverse adaptive color transformer 150. In this way, inverse adaptive color transformer 150 may receive a transform block of a TU.

Inverse adaptive color transformer 150 may adaptively inversely transform a block of video data having the first color space to a second block of video data having a second, RGB color space. For example, inverse adaptive color transformer 150 may select an inverse transform to apply to a transform block of a TU. In this example, inverse adaptive color transformer 150 may apply the selected inverse transform to the transform block in order to transform the transform block from the first color space to the RGB color space. Prediction compensation unit 152 may combine a reference picture from memory 154. For example, prediction compensation unit 152 may receive a transform block of a TU of a CU. In this example, prediction compensation unit 152 may determine a coding block for the CU. In this example, each sample of the coding block of the CU may be equal to a sum of a sample in the transform block and a corresponding sample in a prediction block for a PU of the CU. Deblock filter 156 may deblock the combined, reconstructed image. SAO filter unit 158 may perform additional SAO filtering if applicable.

The output of SAO filter 158 is reconstructed signal 160. If video decoder 30B is configured to inversely color transform blocks of residual video data, switch 162 feeds reconstructed signal 160 to reference picture memory 154 for future use as a reference picture. Video decoder 30B may also output reconstructed signal 160 as image/video 164.

In examples where video decoder 30B is configured to inversely color transform blocks of the original input signal as opposed to blocks of residual video data, entropy decoding unit 142 and dequantization/inverse transform unit 144 operate in the manner previously described. Switch 148 is in the alternate position and feeds reconstructed residual signal directly to prediction compensation unit 152. At this point, the residual block provided to prediction compensation unit 152 is still in the first color space, rather than the RGB color space.

Prediction compensation unit 152 may reconstruct a block of the original image and may combine the residual block with one or more blocks of pictures from reference picture memory 154. Deblock filter 156 and SAO filter 158 may operate as described above with respect to inversely transforming residual blocks of video data. The output of SAO filter 158 is reconstructed signal 160, the blocks of which are still in the first color space, and may not be have the RGB color space (e.g., the blocks may still have the RGB color space if the identity transform was used).

Reconstructed signal 160 may be fed to inverse adaptive color transformer 166 via switch 162, which is in the alternate position as compared to the position illustrated in FIG. 5. Inverse adaptive color transformer 166 may inversely color transform a block of reconstructed signal having a first color space to a second block of video data having a second, RGB color space using an inverse color transform of one or more inverse color transforms. In some examples, the particular inverse transform that decoder 30B uses may be signaled in bitstream 140. Inverse adaptive color transformer 166 may feed the second block having the second color space for output as image/video 164, as well as to reference picture memory 154 for future storage and usage as a reference picture.

In this manner, video decoder 30B represents an example of a video coder device configured to determine a cost associated with a plurality of inverse color transforms, and select an inverse color transform of the plurality of inverse color transforms having a lowest associated cost. Video decoder 30B may be further configured to adaptively inversely transforming a first block of video data having a first color space to a second block of video having a second, red, green, blue (RGB) color space using the selected inverse color transform of the plurality of inverse color transforms, and decode the second video block having the second, RGB color space.

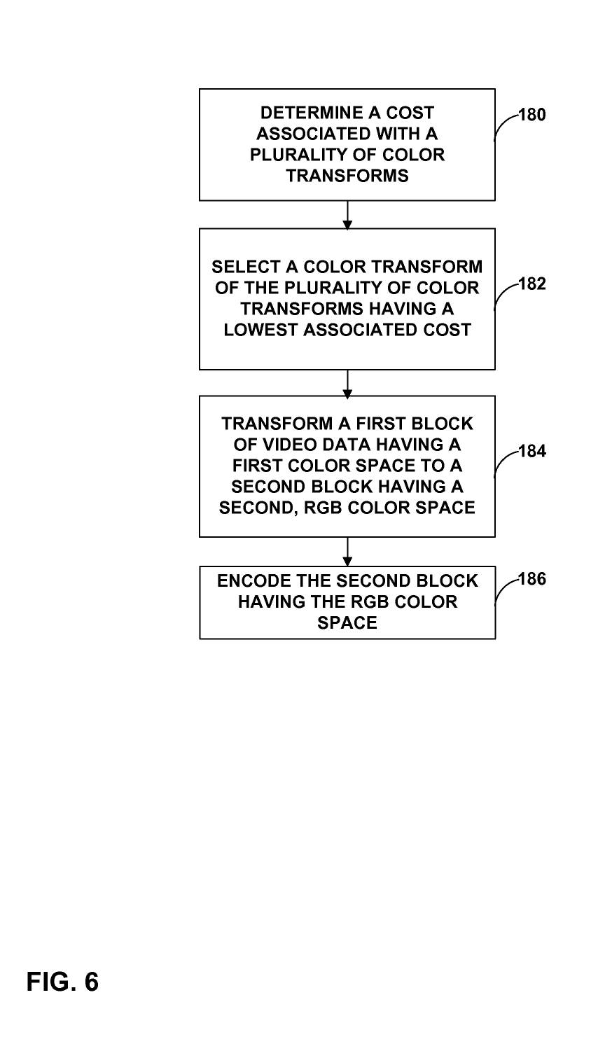

FIG. 6 is a flowchart illustrating a process for transforming video data having an RGB color space to video data having a second color space using a color transform in accordance with one or more aspects of this disclosure. For purposes of illustration only, the method of FIG. 6 may be performed by a video encoder, such as a video encoder corresponding to video encoder 20, 20A, and/or 20B of FIGS. 1, 2, and 4.

In the method of FIG. 6, video encoder 20 may determine a cost associated with a plurality of color transforms associated with a coding unit (180), and select a color transform from a plurality of color transforms having a lowest associated cost (182). Video encoder 20 may be further configured to transform a first block of video data having a first RGB color space to a second block of video having a second color space using the selected color transform of the plurality of color transforms (184). Furthermore, video encoder 20 may encode the second video block having the second color space (186). In some examples, encoding the second block of video may comprise encoding an original block. In some examples, encoding may comprise encoding a residual block.

In some examples the one or more color transforms may comprise one or more of a group consisting of: an identity transform, a differential transform, a weighted differential transform, a discrete cosine transform (DCT), a YCbCr transform, a YCgCo transform, and a YCgCo—R transform. The color transforms will now be discussed in greater detail.

In some examples the identity transform comprises:

$$[ \begin{matrix}1 & 0 & 0 \\ 0 & 1 & 0 \\ 0 & 0 & 1\end{matrix} ] .$$

In some examples, the differential transform comprises:

$$[ \begin{matrix}0 & 1 & 0 \\ 0 & - 1 & 1 \\ 1 & - 1 & 0\end{matrix} ] .$$

In some examples, the DCT transform comprises:

$$[ \begin{matrix}0.5774 & 0.5774 & 0.5774 \\ 0.7071 & 0 & - 0.7071 \\ 0.4082 & - 0.8156 & 0.4082\end{matrix} ] .$$

In some examples, the YCbCr transform comprises:

$$[ \begin{matrix}0.2126 & 0.7152 & 0.0722 \\ - 0.1172 & - 0.3942 & 0.5114 \\ 0.5114 & - 0.4645 & - 0.0469\end{matrix} ] .$$

In some examples,

the YCgCo transform comprises:

$$[ \begin{matrix}1 \text{/} 4 & 1 \text{/} 2 & 1 \text{/} 4 \\ 1 \text{/} 2 & 0 & - 1 \text{/} 2 \\ - 1 \text{/} 4 & 1 \text{/} 2 & - 1 \text{/} 4\end{matrix} ] .$$

In some examples, the YCgo-R transform comprises:

Co=R−B

t=B+└Co/2┘

Cg=G−t

Y=t+└Cg/2┘.

In various examples, video encoder 20, 20A, or 20B may derive any of the color transforms described herein, including the selected color transform using a lifting scheme. The lifting scheme may correspond to:

R′=R+└aB┘

B′=B+└bR′┘

G′=G+└cB′┘

R″=R′+└dG′┘,

wherein a, b, c, and d are parameters. Video encoder 20, 20A, or 20B may further utilize a variation of the lifting scheme according to:

R′″=└eR″+f┘

B″=└gB′+h┘,

G″=└iG′+j┘

wherein e, f, g, h, I, and j are parameters. In these lifting scheme examples, R, B, and G may correspond to red, green, and blue samples. As part of deriving one or more color transforms using the lifting scheme, video encoder 20 may normalize a bit depth of each color channel of the lifting scheme.

In some examples, the weighted differential transform comprises:

$$[ \begin{matrix}0 & 1 & 0 \\ 0 & - {α}_{1} & 1 \\ 1 & - {α}_{2} & 0\end{matrix} ] .$$

In some examples of the differential transform, α₁=cov(G, B)/var(G), α₂=cov(G, R)/var(G). R corresponds to a red color channel of the RGB color space. G corresponds to a green color channel of the RGB color space, B corresponds to a blue color channel of the RGB color space, “cov( )” is the covariance function, and “var( )” is the variance function. In some examples, the covariance function and the variance functions are calculated using a set of reference pixels.

In various examples, video encoder 20 may encode values of α₁ and α₂. The values of α₁ and α₂ may also be constrained to a set of values comprising at least one of a group consisting of: a set of integers, a set of dyadic numbers, and a set of fractions with a dyadic number.

In some examples, in the method of FIG. 6 video encoder 20 may further signal data that indicates the color transform of the one or more color spaces has been applied to the second video block having the second color space.

In some examples, in the method of FIG. 6, the first block may comprise a block of a plurality of blocks in a picture of video data, and video encoder 20 may be further configured to determine whether to apply a single transform of the one or more color transforms to the plurality of blocks. Responsive to determining to apply the single transform to the plurality of blocks, video encoder 20 may signal, for each of the plurality of blocks, a flag syntax element. The first value of the flag indicates that the single transform has been applied, and the second value of the flag indicates that the single transform has not been applied.

In various examples, the first block of video data may comprise at least one of: a CTU, CU, PU, and a TU.

In other examples, the first block comprises a single block of a plurality of blocks in a picture of video data, and video encoder 20 is further configured to determine whether to apply a single color transform of the one or more of color transforms to each one of the blocks of video data, responsive to determining to apply the single color transform to each one of the blocks, and transform each of the blocks using the single color transform without signaling data indicating that the single color transform has been applied to each one of the blocks of video data.

In another example, video encoder 20A may be configured to select the color transform of the plurality of color transforms of the plurality of color transforms that minimizes a Lagrangian cost corresponding to: L=D+λR, wherein L is the Lagrange cost, D is a distortion value, λ is a Lagrange multiplier, and R is a bitrate value. Video encoder 20A may be further configured to signal a syntax element that indicates the selected color transform in a coded video bitstream. The signaled syntax element may comprise an index value corresponding to the selected color transform.

In some examples, video encoder 20 may be further configured to determine a distortion cost associated with each of the one or more color transforms. Video encoder 20 may then select the color transform having the lowest associated distortion cost and transform the first video block having the RGB color space to the second video block using the selected color transform. Video encoder 20 may be further configured to signal a syntax element that indicates the selected color transform, i.e. the transform having the lowest associated distortion cost, in a coded video bitstream. The signaled syntax element may comprise an index value corresponding to the selected color transform.

In various examples, video encoder 20 may be further configured to determine a correlation between color components of the RGB color space of the first video block and each color space associated with each of the one or more color transforms, wherein the color transform used to transform the first video block having the RGB color space to the second video block having the second color space is the color transform of the plurality of color transforms that is associated with the color space having a highest associated correlation.

In some examples, the first block of data may comprise a block of residual data, or the first block of video data may comprise a block of video data of an original signal.

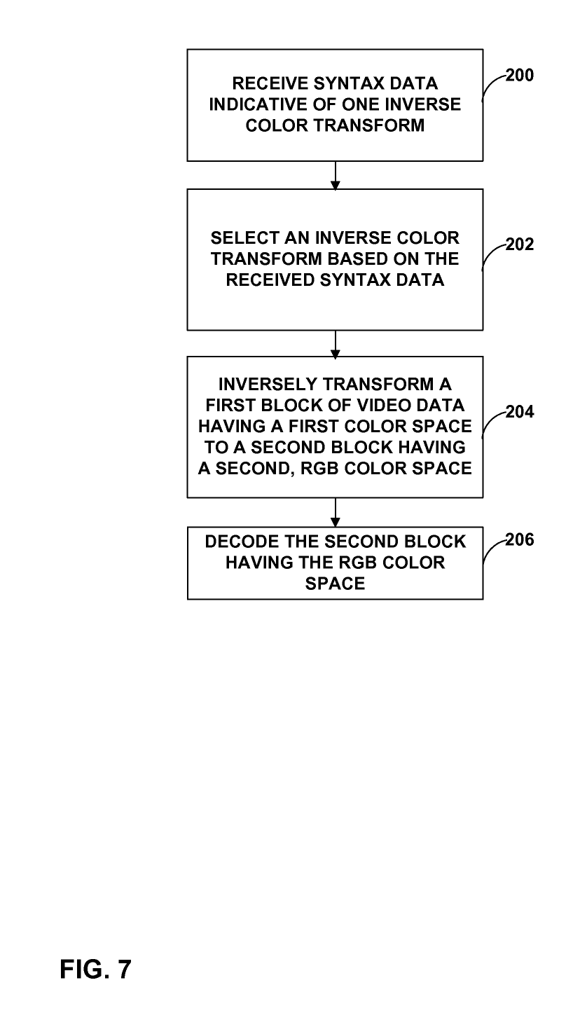

FIG. 7 is a flowchart illustrating a process for transforming video data having a first color space to video data having a second, RGB color space using an inverse color transform in accordance with one or more aspects of this disclosure. For purposes of illustration only, the method of FIG. 7 may be performed by a video decoder, such as a video encoder corresponding to video decoder 30, 30A, and/or 30B, illustrated in FIGS. 1, 3, and 5.

In the method of FIG. 7, video decoder 30 may receive syntax data associated with a coded unit in a bitstream, the syntax data indicative of one of a plurality of inverse color transforms (200), and select an inverse color transform of the plurality of inverse color transforms based on the received syntax data (202). Video decoder 30 may inversely transform a first block of video data having a first color space to a second block of video having a second, Red, Green, Blue (RGB) color space using the selected inverse color transform of the plurality of inverse color transforms (204). Furthermore, video decoder 30 may decode the second video block having the second, RGB color space (206). In some examples, the decoded block may comprise an original block of transform coefficients. In some examples, the decoded block may comprise a residual block of transform coefficients.

In various examples, the one or more inverse color transforms may comprise at least one of a group consisting of: one or more of an inverse identity transform, an inverse differential transform, an inverse weighted differential transform, an inverse discrete cosine transform (DCT), an inverse YCbCr transform, an inverse YCgCo transform, and an inverse YCgCo—R transform. The one or more inverse color transforms will now be described.

In various examples, the identity transform comprises:

$$[ \begin{matrix}1 & 0 & 0 \\ 0 & 1 & 0 \\ 0 & 0 & 1\end{matrix} ] .$$

In some examples, the inverse differential transform comprises:

$$[ \begin{matrix}0 & 1 & 0 \\ 0 & - 1 & 1 \\ 1 & - 1 & 0\end{matrix} ] .$$

In some examples, the inverse DCT transform comprises:

$$[ \begin{matrix}0.5774 & 0.7071 & 0.4082 \\ 0.5774 & 0 & - 0.8156 \\ 0.5774 & - 0.7071 & 0.4082\end{matrix} ] .$$

In some examples, wherein the inverse YCbCr transform comprises:

$$[ \begin{matrix}1 & 0 & 1.5397 \\ 1 & - 0.1831 & - 0.4577 \\ 1 & 1.8142 & 0\end{matrix} ] .$$

In some examples, the inverse YCgCo transform comprises:

$$[ \begin{matrix}1 & 0 & 1.5397 \\ 1 & - 0.1831 & - 0.4577 \\ 1 & 1.8142 & 0\end{matrix} ] .$$

In some examples, the inverse YCgCo—R transform comprises:

t=Y−└Cg/2┘

G=Cg+t

B=t−└Co/2┘

R=B+Co,

In various examples, video decoder 30 may derive one or more of the inverse color transforms, such as the selected inverse color transform using a lifting scheme corresponding to:

R′=R+└aB┘

B′=B+└bR′┘

G′=G+└cB′┘

R″=R′+└dG′┘,

wherein a, b, c, and d are parameters. In various examples, video decoder 30 may be configured to use a further variation of the lifting scheme according to:

R′″=└eR″+f┘

B″=└gB′+h┘,

G″=└iG′+j┘

wherein e, f, g, h, i, and j are parameters. Video decoder 30 may further normalize a bit depth of each color channel of the lifting scheme in some examples.

In various examples, the inverse weighted differential transform comprises:

$$[ \begin{matrix}{α}_{2} & 0 & 1 \\ 1 & 0 & 0 \\ {α}_{1} & 1 & 0\end{matrix} ] .$$

In various examples of the inverse weighted differential transform, α₁=cov(G, B)/var(G), α₂=cov(G, R)/var(G), R corresponds to a red color channel of the RGB color space, G corresponds to a green color channel of the RGB space. B corresponds to a blue color channel of the RGB color space, “cov( )” is the covariance function, and “var( )” is the variance function. In various examples, video decoder 30 may calculate the covariance function and the variance functions using a set of reference pixels. In some examples, video decoder 30 may be further configured to decode values of α₁ and α₂, e.g., based on syntax elements in the coded video bitstream.

In some examples, video decoder 30 may constrain the values of α₁ and α₂ to a set of values comprising at least one of a group consisting of: a set of integers, a set of dyadic numbers, and a set of fractions with a dyadic number.

In various examples, video decoder 30 may implement any of the color transforms described in this disclosure using a lifting scheme corresponding to:

R′=R+└aB┘

B′=B+└bR′┘

G′=G+└cB′┘

R″=R′+└dG′┘,

wherein a, b, c, and d are parameters.

In some examples, video decoder 30 may implement any of the color transforms described in this disclosure using a further variation of the lifting scheme described above. In this variation of the lifting scheme:

R′″=└eR″+f┘

B″=└gB′+h┘,

G″=└iG′+j┘

wherein e, f, g, h, i, and j are parameters.

In various examples, in the method of FIG. 7, video decoder 30 may be further configured to derive one or more of the inverse color transform using a lifting scheme, and normalize a bit depth of each color channel of the lifting scheme.

In various examples, video decoder may be further configured to decode data that indicates the color transform of the one or more color spaces has been applied to the first video block having the first color space.

Video decoder 30 may be further configured to decode a value of a flag syntax element that indicates whether to apply a single inverse transform of the one or more inverse color transforms to the plurality of blocks. A first value of the flag (e.g., a “0” value or a “1” value) may indicate that the single transform has been applied, and a second value of the flag indicates that the single transform has not been applied. Additionally, the first flag value may indicate to inversely transform the plurality of blocks, and the second flag value may indicate not to apply the inverse transform to the plurality of blocks. Video decoder 30 may determine to apply the single inverse color transform to the plurality of blocks based on the value of the flag syntax element, video decoder 30 may inversely transform each block of the plurality of blocks based on a value of the syntax element.

In various examples, the first block of video data may comprise at least one of a group consisting of: a CTU, CU, PU, and a TU.

In yet another example, video decoder 30 may decode a flag syntax element for the coded unit. Video decoder 30 may be further configured to determine whether or not a single color transform of the one or more color transforms has been applied to the first block based on the value of the syntax element. In these examples, a first value of the flag may indicate to apply the single inverse transform, and a second value of the flag indicates not to apply the single inverse transform.

In some examples, video decoder 30 may decode a syntax element that indicates an inverse color transform of the plurality of plurality of inverse color transforms that optimizes a Lagrangian cost corresponding to: L=D+λR. In this examples, L is the Lagrange cost, D is a distortion value, λ is a Lagrange multiplier, and R is a bitrate value.

In various examples, the first block of data may comprise a block of a reconstructed signal. Alternatively, the first block may comprise a block of a reconstructed residual signal. The first block may be at least one of a group consisting of a residual block and a predictive block.

In some examples, the inverse color transform used to inversely transform the first video block having the first color space to the second video block having the second, RGB color space is the inverse color transform of the one or more inverse color transforms that has a lowest associated distortion cost.

In some examples, the color transform used to transform the first video block having the first color space to the second video block having the second, RGB color space is the inverse color transform of the one or more inverse color transforms that is associated with a color space having a highest associated correlation between color components of the RGB color space and each of a plurality of color components associated with each of the one or more inverse color transforms.

In various other examples, the first block of data comprises a block of residual data. In another example, the first block of video data comprises a block of video data of an original signal.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

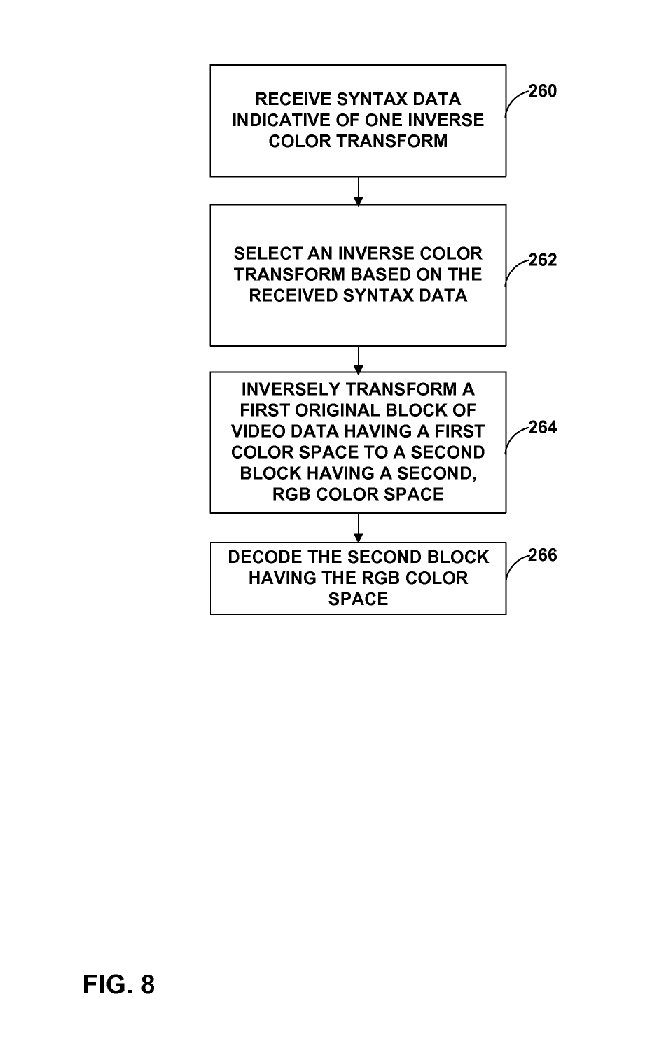

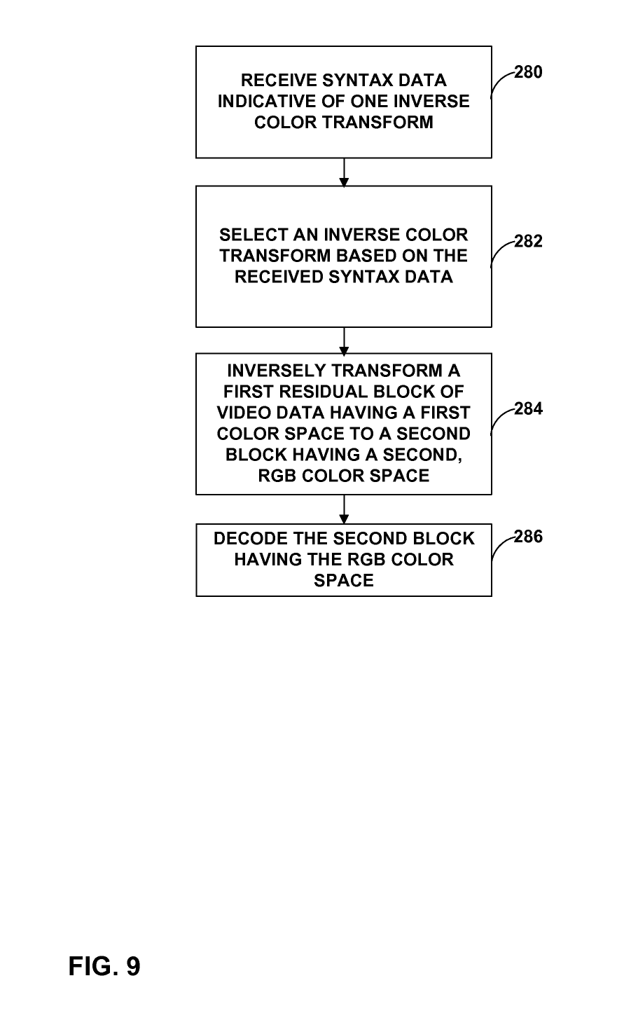

FIG. 8 is a flowchart illustrating a process for transforming a block of video data having a first color space to a block of video data having a second, RGB color space. Video decoder 30B may be configured to perform the process illustrated in FIG. 9. Video decoder 30B may be configured to receive syntax data associated with a coded unit in a bitstream, the syntax data indicative of one of a plurality of inverse color transforms (260), and select an inverse color transform of the plurality of inverse color transforms based on the received syntax data (262). Video decoder 30A may be further configured to transform a first original block of video data having a first. Red, Green, Blue (RGB) color space to produce a second block of video data having a second color space using the selected color transform having the lowest associated cost (264), and decode the second video block having the second color space (266).

FIG. 9 is a flowchart illustrating a process for transforming a block of video data having a first color space to a block of video data having a second, RGB color space. Video decoder 30B may be configured to perform the process illustrated in FIG. 9. Video decoder 30B may be configured to receive syntax data associated with a coded unit in a bitstream, the syntax data indicative of one of a plurality of inverse color transforms (280), and select an inverse color transform of the plurality of inverse color transforms based on the received syntax data (282). Video decoder 30B may be further configured to inversely transform a first residual block of video data having a first, Red, Green, Blue (RGB) color space to produce a second block of video data having a second color space using the selected color transform having the lowest associated cost (284), and decode the second video block having the second color space (286).

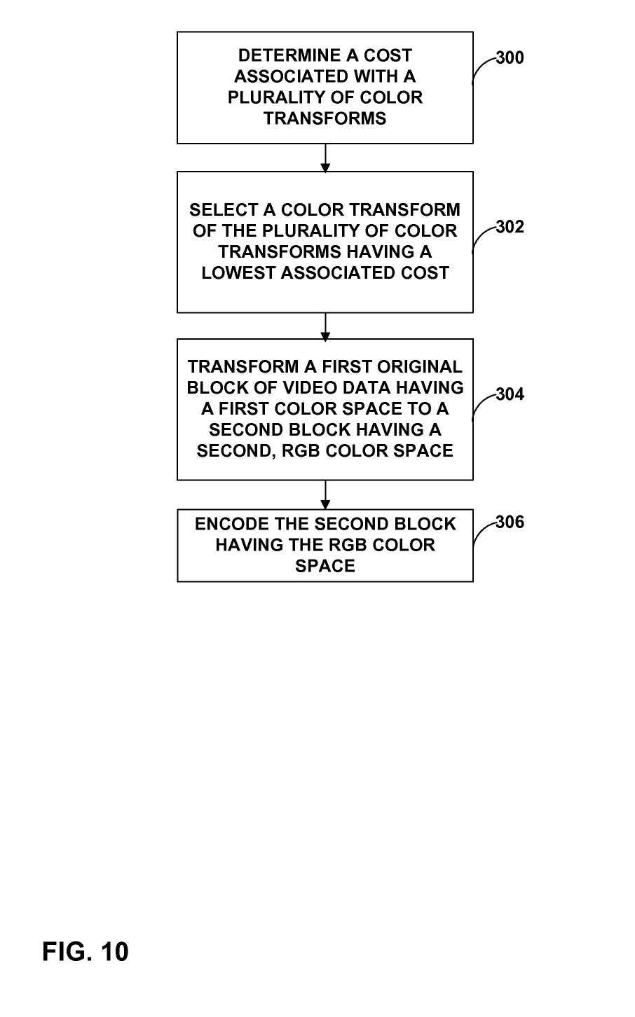

FIG. 10 is a flowchart illustrating a process for transforming an original block of video data having a first color space to a block of video data having a second, RGB color space. Video encoder 20A may be configured to perform the process illustrated in FIG. 9. Video encoder 20A may be configured to determine cost associated with a plurality of color transforms (300), and select a color transform of the plurality of color transforms having a lowest associated cost (302). Video encoder 20A may be further configured to transform a first original block of video data having a first. Red, Green, Blue (RGB) color space to produce a second block of video data having a second color space using the selected color transform having the lowest associated cost (304), and encode the second video block having the second color space (306).

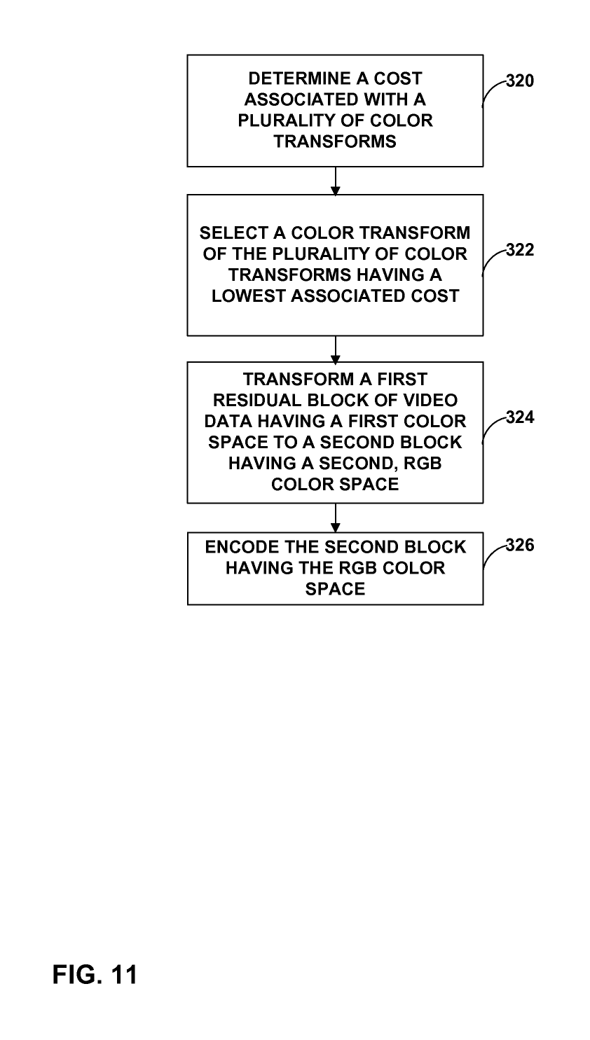

FIG. 11 is a flowchart illustrating a process for transforming a residual block of video data having a first color space to a block of video data having a second, RGB color space. Video encoder 20A may be configured to perform the process illustrated in FIG. 9. Video encoder 20A may be configured to determine cost associated with a plurality of color transforms (320), and select a color transform of the plurality of color transforms having a lowest associated cost (322). Video encoder 20A may be further configured to transform a first residual block of video data having a first, Red. Green, Blue (RGB) color space to produce a second block of video data having a second color space using the selected color transform having the lowest associated cost (324), and encode the second video block having the second color space (326).

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples, as well as particular combination of such examples, are within the scope of the following claims.

What is claimed is:

1. A method of encoding video data, the method comprising:
determining a cost associated with a plurality of color transforms associated with a coding unit;
selecting a color transform of the plurality of color transforms having a lowest associated cost;
transforming a first block of video data having a first, Red, Green, Blue (RGB) color space to produce a second block of video data having a second color space using the selected color transform of the plurality of color transforms; and
encoding the second video block having the second color space.

2. The method of claim 1, wherein the plurality of color transforms comprise a plurality of transforms of a group consisting of: an identity transform, a differential transform, a weighted differential transform, a discrete cosine transform (DCT), a YCbCr transform, a YCgCo transform, and a YCgCo—R transform.

3. The method of claim 2, wherein the identity transform comprises:
$$[ \begin{matrix}1 & 0 & 0 \\ 0 & 1 & 0 \\ 0 & 0 & 1\end{matrix} ] .$$

4. The method of claim 2, wherein the differential transform comprises:
$$[ \begin{matrix}0 & 1 & 0 \\ 0 & - 1 & 1 \\ 1 & - 1 & 0\end{matrix} ] .$$

5. The method of claim 2, wherein the DCT transform comprises:
$$[ \begin{matrix}0.5774 & 0.5774 & 0.5774 \\ 0.7071 & 0 & - 0.7071 \\ 0.4082 & - 0.8156 & 0.4082\end{matrix} ] .$$

6. The method of claim 2, wherein the YCbCr transform comprises:
$$[ \begin{matrix}0.2126 & 0.7152 & 0.0722 \\ - 0.1172 & - 0.3942 & 0.5114 \\ 0.5114 & - 0.4645 & - 0.0469\end{matrix} ] .$$

7. The method of claim 2, wherein the YCgCo transform comprises:
$$[ \begin{matrix}1 \text{/} 4 & 1 \text{/} 2 & 1 \text{/} 4 \\ 1 \text{/} 2 & 0 & - 1 \text{/} 2 \\ - 1 \text{/} 4 & 1 \text{/} 2 & - 1 \text{/} 4\end{matrix} ] .$$

8. The method of claim 1, wherein the selected color transform comprises a YCgCo—R transform comprising:
Co=R−B
t=B+└Co/2┘
Cg=G−t
Y=t+└C/2┘.

9. The method of claim 1, wherein the selected color transform is derived using a lifting scheme corresponding to:
R′=R+└aB┘
B′=B+└bR′┘
G′=G+└cB′┘
R″=R′+└dG′┘,
wherein a, b, c, and d are parameters.

10. The method of claim 9, wherein the lifting scheme further comprises:
R′″=└eR″+f┘
B″=└gB′+h┘
G″=└iG′+j┘
wherein e, f, g, h, i, and j are parameters.

11. The method of claim 9, further comprising:
normalizing a bit depth of each color channel of the lifting scheme.

12. The method of claim 1, wherein the selected color transform comprises a weighted differential transform comprising:
$$[ \begin{matrix}0 & 1 & 0 \\ 0 & - {α}_{1} & 1 \\ 1 & - {α}_{2} & 0\end{matrix} ] ,$$
wherein α₁=cov(G, B)/var(G),
wherein α₂=cov(G, R)/var(G),
wherein R corresponds to a red color channel of the RGB color space,
wherein G corresponds to a green color channel of the RGB color space,
wherein B corresponds to a blue color channel of the RGB color space,
wherein cov( ) is the covariance function, and
wherein var( ) is the variance function.

13. The method of claim 12, wherein the covariance function and the variance functions are calculated using a set of reference pixels.

14. The method of claim 12, further comprising encoding values of α₁ and α₂.

15. The method of claim 12, wherein the values of α₁ and α₂ are constrained to a set of values comprising at least one of a group consisting of:
a set of integers, a set of dyadic numbers, and a set of fractions with a dyadic number.

16. The method of claim 1, further comprising:
signaling data that indicates the selected, second color transform of the plurality of color transforms has been applied to the second video block having the second color space.

17. The method of claim 1, the method further comprising:
determining whether to apply a single transform of the plurality of color transforms to the first block;
responsive to determining to apply the single transform to the plurality of blocks, signaling, for the coded unit, a flag syntax element, wherein a first value of the flag indicates that the single transform has been applied, and wherein a second value of the flag indicates that the single transform has not been applied.

18. The method of claim 1, wherein the first block comprises at least one of a group consisting of:
a coding tree unit (CTU), coding unit (CU), prediction unit (PU), and a transform unit (TU).

19. The method of claim 1, wherein the first block comprises a plurality of blocks, the method further comprising:
determining whether to apply a pre-defined color transform of the plurality of color transforms to each one of the plurality of blocks; and
responsive to determining to apply the pre-defined color transform to each one of the plurality of blocks, transforming each of the plurality of blocks using the pre-defined color transform without signaling data indicating that the pre-defined color transform has been applied to each one of the plurality blocks of video data.

20. The method of claim 1, wherein the selected color transform of the plurality of color transforms comprises the color transform of the plurality of color transforms that minimizes a Lagrangian cost corresponding to: L=D+λR,
wherein L is the Lagrange cost, D is a distortion value, λ is a Lagrange multiplier, and R is a bitrate value; and
encoding an index syntax element that indicates the selected color transform.

21. The method of claim 1, wherein the selected color transform is a color transform of the plurality of color transforms that has a lowest associated distortion cost, the method further comprising:
encoding an index syntax element that indicates the selected color transform.

22. The method of claim 1, the method further comprising:
determining a correlation between color components of the RGB color space of the first video block and each color space associated with each of the plurality of color transforms; and
signaling an index syntax element that indicates the selected color transform,
wherein the selected is a color transform of the plurality of color transforms that is associated with the color space having a highest associated correlation between the color components.

23. The method of claim 22, further comprising: determining the highest associated correlation based on reconstructed neighboring blocks relative to at least one of the first block and the second block.

24. The method of claim 1, wherein the first block of data comprises a block of an original signal.

25. The method of claim 1, wherein the first block comprises a block of a residual signal, and
wherein the first block comprises at least one of a group consisting of: a predictive block and a residual block.

26. A method of decoding video data, the method comprising:
receiving syntax data associated with a coded unit in a bitstream, the syntax data indicative of one of a plurality of inverse color transforms;
selecting an inverse color transform of the plurality of inverse color transforms based on the received syntax data;
inversely transforming a first block of video data having a first color space to a second block of video having a second, red, green, blue (RGB) color space using the selected inverse color transform of the plurality of inverse color transforms; and
decoding the second video block having the second, RGB color space.

27. The method of claim 26, wherein the plurality of inverse color transforms comprises a plurality of inverse color transforms of a group consisting of: an identity transform, an inverse differential transform, an inverse weighted differential transform, an inverse discrete cosine transform (DCT), an inverse YCbCr transform, an inverse YCgCo transform, and an inverse YCgCo—R transform.

28. The method of claim 27, wherein the identity transform comprises:
$$[ \begin{matrix}1 & 0 & 0 \\ 0 & 1 & 0 \\ 0 & 0 & 1\end{matrix} ] .$$

29. The method of claim 27, wherein the inverse differential transform comprises:
$$[ \begin{matrix}1 & 0 & 1 \\ 1 & 0 & 0 \\ 1 & 1 & 0\end{matrix} ] .$$

30. The method of claim 27, wherein the inverse DCT transform comp rises:
$$[ \begin{matrix}0.5774 & 0.7071 & 0.4082 \\ 0.5774 & 0 & - 0.8156 \\ 0.5774 & - 0.7071 & 0.4082\end{matrix} ] .$$

31. The method of claim 27, wherein the inverse YCbCr transform comprises:
$$[ \begin{matrix}1 & 0 & 1.5397 \\ 1 & - 0.1831 & - 0.4577 \\ 1 & 1.8142 & 0\end{matrix} ] .$$

32. The method of claim 27, wherein the inverse YCgCo transform comprises:
$$[ \begin{matrix}1 & 1 & - 1 \\ 1 & 0 & 1 \\ 1 & - 1 & - 1\end{matrix} ] .$$

33. The method of claim 26, wherein the selected inverse color transform comprises a YCgCo—R transform comprising:
t=Y−└Cg/2┘
G=Cg+t
B=t−└Co/2┘
R=B+Co.

34. The method of claim 26, wherein the selected inverse color transform is derived using a lifting scheme corresponding to:
R′=R+└aB┘
B′=B+└bR′┘
G′=G+└cB′┘
R″=R′+└dG′┘,
wherein a, b, c, and d are parameters.

35. The method of claim 34, wherein the lifting scheme further comprises:
R′″=└eR″+f┘
B″=└gB′+h┘,
G″=└iG′+i┘
wherein e, f, g, h, i, and j are parameters.

36. The method of claim 34, further comprising normalizing a bit depth of each color channel of the lifting scheme.

37. The method of claim 26, wherein the selected inverse color transform comprises a weighted differential transform comprising:
$$[ \begin{matrix}{α}_{2} & 0 & 1 \\ 1 & 0 & 0 \\ {α}_{1} & 1 & 0\end{matrix} ] ,$$
wherein α₁=cov(G, B)/var(G),
wherein α₂=cov(G, R)/var(G),
wherein R corresponds to a red color channel of the RGB color space,
wherein G corresponds to a green color channel of the RGB space,
wherein B corresponds to a blue color channel of the RGB color space,
wherein cov( ) is the covariance function, and
wherein var( ) is the variance function.

38. The method of claim 37, wherein the covariance function and the variance functions are calculated using a set of reference pixels.

39. The method of claim 37, further comprising decoding values of α₁ and α₂.

40. The method of claim 37, wherein the values of α₁ and α₂ are constrained to a set values comprising at least one of a group consisting of:
a set of integers, a set of dyadic numbers, and a set of fractions with a dyadic number.

41. The method of claim 26, further comprising:
decoding data that indicates the selected inverse color transform of the plurality of color inverse transforms to apply to the first video block having the first color space.

42. The method of claim 26, the method further comprising:
decoding a value of a flag syntax element for the coded unit; and
determining whether to apply a single inverse transform of the plurality of inverse color transforms to the first block based on the value of the flag syntax element,
wherein a first value of the flag indicates to apply the single inverse transform; and
wherein a second value of the flag indicates not to apply the single inverse transform.

43. The method of claim 26, wherein the first block of video data comprises at least one of a group consisting of:
a coding tree unit (CTU), coding unit (CU), prediction unit (PU), and a transform unit (TU).

44. The method of claim 26, wherein the first block comprises a plurality of blocks, the method further comprising:
determining whether to apply a pre-defined inverse color transform of the plurality of inverse color transforms to each one of the plurality of blocks; and
responsive to determining to apply the pre-defined inverse color transform to each one of the plurality of blocks, inversely transforming each of the plurality of blocks using the pre-defined color transform without decoding data indicating that the pre-defined color transform has been applied to each one of the plurality blocks of video data.

45. The method of claim 26, further comprising: decoding an index syntax element that indicates the selected inverse color transform,
wherein the selected inverse color transform of the plurality of color transforms comprises the inverse color transform of the plurality of color transforms that minimizes a Lagrangian cost corresponding to: L=D+λR,
wherein L is the Lagrange cost, D is a distortion value, λ is a Lagrange multiplier, and R is a bitrate value.

46. The method of claim 26, further comprising:
decoding an index syntax element that indicates the selected inverse color transform,
wherein the selected inverse color transform is the inverse color transform of the plurality of color transforms that has a lowest associated distortion cost.

47. The method of claim 26,
wherein the selected inverse color transform is an inverse color transform of the plurality of color transforms that is associated with a color space having a highest associated correlation between color components of the RGB color space and each of a plurality of color components associated with each of the plurality of color transforms.

48. The method of claim 46, wherein the received syntax data comprises syntax data of reconstructed neighboring blocks relative to at least one of the first block and the second block,
the method further comprising: determining the highest associated correlation based on the syntax data of the reconstructed neighboring blocks.

49. The method of claim 46, further comprising decoding an index syntax element that indicates the selected inverse color transform that has the highest associated correlation.

50. The method of claim 26, wherein the first block of data comprises a block of a reconstructed signal.

51. The method of claim 26, wherein the first block of video data comprises a block of a reconstructed residual signal,
wherein the first block comprises at least one of a group consisting of: a predictive block and a residual block.

52. A device for encoding video data, the device comprising:
a memory configured to store video data; and
at least one processor configured to:
determine a cost associated with a plurality of color transforms associated with a coding unit;
select a color transform of the plurality of color transforms having a lowest associated cost;
transform a first block of video data having a first, Red, Green, Blue (RGB) color space to produce a second block of video data having a second color space using the selected color transform of the plurality of color transforms; and
encode the second video block having the second color space.

53. The device of claim 52, wherein the device comprises at least one of:
an integrated circuit;
a microprocessor; and
a wireless communication device.

54. The device of claim 52, wherein the plurality of color transforms comprises a plurality of a group consisting of: an identity transform, a differential transform, a weighted differential transform, a discrete cosine transform (DCT), a YCbCr transform, a YCgCo transform, and a YCgCo—R transform.

55. The device of claim 52, wherein the identity transform comprises:
$$[ \begin{matrix}1 & 0 & 0 \\ 0 & 1 & 0 \\ 0 & 0 & 1\end{matrix} ] .$$

56. The device of claim 52, wherein the differential transform comprises:
$$[ \begin{matrix}0 & 1 & 0 \\ 0 & - 1 & 1 \\ 1 & - 1 & 0\end{matrix} ] .$$

57. The device of claim 52, wherein the DCT transform comprises:
$$[ \begin{matrix}0.5774 & 0.5774 & 0.5774 \\ 0.7071 & 0 & - 0.7071 \\ 0.4082 & - 0.8156 & 0.4082\end{matrix} ] .$$

58. The device of claim 52, wherein the YCbCr transform comprises:
$$[ \begin{matrix}0.2126 & 0.7152 & 0.0722 \\ - 0.1172 & - 0.3942 & 0.5114 \\ 0.5114 & - 0.4645 & - 0.0469\end{matrix} ] .$$

59. The device of claim 52, wherein the YCgCo transform comprises:
$$[ \begin{matrix}1 \text{/} 4 & 1 \text{/} 2 & 1 \text{/} 4 \\ 1 \text{/} 2 & 0 & - 1 \text{/} 2 \\ - 1 \text{/} 4 & 1 \text{/} 2 & - 1 \text{/} 4\end{matrix} ] .$$

60. The device of claim 52, wherein the selected color transform comprises a YCgCo—R transform comprising:
Co=R−B
t=B+└Co/2┘
Cg=G−t
Y=t+└C/2┘.

61. The device of claim 52, wherein the selected color transform is derived using a lifting scheme corresponding to:
R′=R+└aB┘
B′=B+└bR′┘
G′=G+└cB′┘
R″=R′+└dG′┘,
wherein a, b, c, and d are parameters.

62. The device of claim 61, wherein the lifting scheme further comprises:
R′″=└eR″+f┘
B″=└B′+h┘
G″=└iG′+j┘
wherein e, f, g, h, i, and j are parameters.

63. The device of claim 61, wherein the at least one processor is further configured to:
normalize a bit depth of each color channel of the lifting scheme.

64. The device of claim 52, wherein the selected color transform comprises a weighted differential transform comprising:
$$[ \begin{matrix}0 & 1 & 0 \\ 0 & - {α}_{1} & 1 \\ 1 & - {α}_{2} & 0\end{matrix} ] ,$$
wherein α₁=cov(G, B)/var(G),
wherein α₂=cov(G, R)/var(G),
wherein R corresponds to a red color channel of the RGB color space,
wherein G corresponds to a green color channel of the RGB color space,
wherein B corresponds to a blue color channel of the RGB color space,
wherein cov( ) is the covariance function, and
wherein var( ) is the variance function.

65. The device of claim 64, wherein the covariance function and the variance functions are calculated using a set of reference pixels.

66. The device of claim 64, further comprising encoding values of α₁ and α₂.

67. The device of claim 64, wherein the values of α₁ and α₂ are constrained to a set of values comprising at least one of a group consisting of:
a set of integers, a set of dyadic numbers, and a set of fractions with a dyadic number.

68. The device of claim 52, wherein the at least one processor is further configured to:
signal data that indicates the selected, second color transform of the plurality of color transforms has been applied to the second video block having the second color space.

69. The device of claim 52, wherein the at least one processor is further configured to:
determine whether to apply a single transform of the plurality of color transforms to the first block;
responsive to determining to apply the single transform to the plurality of blocks, signal, for the coded unit, a flag syntax element, wherein a first value of the flag indicates that the single transform has been applied, and wherein a second value of the flag indicates that the single transform has not been applied.

70. The device of claim 52, wherein the first block comprises at least one of a group consisting of:
a coding tree unit (CTU), coding unit (CU), prediction unit (PU), and a transform unit (TU).

71. The device of claim 52, wherein the first block comprises a plurality of blocks, wherein the at least one processor is further configured to:
determine whether to apply a pre-defined color transform of the plurality of color transforms to each one of the plurality of blocks; and
responsive to determining to apply the pre-defined color transform to each one of the plurality of blocks, transform each of the plurality of blocks using the pre-defined color transform without signaling data indicating that the pre-defined color transform has been applied to each one of the plurality blocks of video data.

72. The device of claim 52, wherein the selected color transform of the plurality of color transforms comprises the color transform of the plurality of color transforms that minimizes a Lagrangian cost corresponding to: L=D+λR,
wherein L is the Lagrange cost, D is a distortion value, λ is a Lagrange multiplier, and R is a bitrate value; and
encode an index syntax element that indicates the selected color transform.

73. The device of claim 52, wherein the selected color transform is a color transform of the plurality of color transforms that has a lowest associated distortion cost, wherein the at least one processor is further configured to:
encode an index syntax element that indicates the selected color transform.

74. The device of claim 52, wherein the at least one processor is further configured to:
determine a correlation between color components of the RGB color space of the first video block and each color space associated with each of the plurality of color transforms; and
signal an index syntax element that indicates the selected color transform,
wherein the selected is a color transform of the plurality of color transforms that is associated with the color space having a highest associated correlation between the color components.

75. The device of claim 74, wherein the at least one processor is further configured to:
determine the highest associated correlation based on reconstructed neighboring blocks relative to at least one of the first block and the second block.

76. The device of claim 52, wherein the first block of data comprises a block of an original signal.

77. The device of claim 52, wherein the first block comprises a block of a residual signal, and
wherein the first block comprises at least one of a group consisting of: a predictive block and a residual block.

78. A device for decoding video data, the device comprising:
a memory configured to store video data; and
at least one processor configured to:
receive syntax data associated with a coded unit in a bitstream, the syntax data indicative of one of a plurality of inverse color transforms:
select an inverse color transform of the plurality of inverse color transforms based on the received syntax data;
inversely transform a first block of video data having a first color space to a second block of video having a second, red, green, blue (RGB) color space using the selected inverse color transform of the plurality of inverse color transforms; and
decode the second video block having the second, RGB color space.

79. The device of claim 78, wherein the device comprises at least one of:
an integrated circuit;
a microprocessor; and
a wireless communication device.

80. The device of claim 78, wherein the plurality of inverse color transforms comprises a plurality of inverse color transforms of a group consisting of: an identity transform, an inverse differential transform, an inverse weighted differential transform, an inverse discrete cosine transform (DCT), an inverse YCbCr transform, an inverse YCgCo transform, and an inverse YCgCo—R transform.

81. The device of claim 80, wherein the identity transform comprises:
$$[ \begin{matrix}1 & 0 & 0 \\ 0 & 1 & 0 \\ 0 & 0 & 1\end{matrix} ] .$$

82. The device of claim 80, wherein the inverse differential transform comprises:
$$[ \begin{matrix}1 & 0 & 1 \\ 1 & 0 & 0 \\ 1 & 1 & 0\end{matrix} ] .$$

83. The device of claim 80, wherein the inverse DCT transform comprises:
$$[ \begin{matrix}0.5774 & 0.7071 & 0.4082 \\ 0.5774 & 0 & - 0.8156 \\ 0.5774 & - 0.7071 & 0.4082\end{matrix} ] .$$

84. The device of claim 80, wherein the inverse YCbCr transform comprises:
$$[ \begin{matrix}1 & 0 & 1.5397 \\ 1 & - 0.1831 & - 0.4577 \\ 1 & 1.8142 & 0\end{matrix} ] .$$

85. The device of claim 80, wherein the inverse YCgCo transform comprises:
$$[ \begin{matrix}1 & 1 & - 1 \\ 1 & 0 & 1 \\ 1 & - 1 & - 1\end{matrix} ] .$$

86. The device of claim 80, wherein the selected inverse color transform comprises a YCgCo—R transform comprising:
t=Y−└Cg/2┘
G=Cg+t
B=t−└Co/2┘
R=B+Co.

87. The device of claim 78, wherein the selected inverse color transform is derived using a lifting scheme corresponding to:
R′=R+└aB┘
B′=B+└bR′┘
G′=G+└cB′┘
R″=R′+└dG′┘,
wherein a, b, c, and d are parameters.

88. The device of claim 87, wherein the lifting scheme further comprises:
R′″=└eR″+f┘
B″=└gB′+h┘,
G″=└iG′+j┘
wherein e, f, g, h, i, and j are parameters.

89. The device of claim 87, wherein the at least one processor is further configured to normalize a bit depth of each color channel of the lifting scheme.

90. The device of claim 78, wherein the selected inverse color transform comprises a weighted differential transform comprising:
$$[ \begin{matrix}{α}_{2} & 0 & 1 \\ 1 & 0 & 0 \\ {α}_{1} & 1 & 0\end{matrix} ] ,$$
wherein α₁=cov(G, B)/var(G),
wherein α₂=cov(G, R)/var(G),
wherein R corresponds to a red color channel of the RGB color space,
wherein G corresponds to a green color channel of the RGB space,
wherein B corresponds to a blue color channel of the RGB color space,
wherein cov( ) is the covariance function, and
wherein var( ) is the variance function.

91. The device of claim 90, wherein the covariance function and the variance functions are calculated using a set of reference pixels.

92. The device of claim 90, further comprising decoding values of α₁ and α₂.

93. The device of claim 90, wherein the values of α₁ and α₂ are constrained to a set values comprising at least one of a group consisting of:
a set of integers, a set of dyadic numbers, and a set of fractions with a dyadic number.

94. The device of claim 78, wherein the at least one processor is further configured to:
decode data that indicates the selected inverse color transform of the plurality of color inverse transforms to apply to the first video block having the first color space.

95. The device of claim 78, wherein the at least one processor is further configured to:
decode a value of a flag syntax element for the coded unit; and
determine whether to apply a single inverse transform of the plurality of inverse color transforms to the first block based on the value of the flag syntax element,
wherein a first value of the flag indicates to apply the single inverse transform; and
wherein a second value of the flag indicates not to apply the single inverse transform.

96. The device of claim 78, wherein the first block of video data comprises at least one of a group consisting of:
a coding tree unit (CTU), coding unit (CU), prediction unit (PU), and a transform unit (TU).

97. The device of claim 78, wherein the first block comprises a plurality of blocks, wherein the at least one processor is further configured to:
determine whether to apply a pre-defined inverse color transform of the plurality of inverse color transforms to each one of the plurality of blocks; and
responsive to determining to apply the pre-defined inverse color transform to each one of the plurality of blocks, inversely transform each of the plurality of blocks using the pre-defined color transform without decoding data indicating that the pre-defined color transform has been applied to each one of the plurality blocks of video data.

98. The device of claim 78, wherein the at least one processor is further configured to: decode an index syntax element that indicates the selected inverse color transform,
wherein the selected inverse color transform of the plurality of color transforms comprises the inverse color transform of the plurality of color transforms that minimizes a Lagrangian cost corresponding to: L=D+λR,
wherein L is the Lagrange cost, D is a distortion value, λ is a Lagrange multiplier, and R is a bitrate value.

99. The device of claim 78, wherein the at least one processor is further configured to:
decode an index syntax element that indicates the selected inverse color transform,
wherein the selected inverse color transform is the inverse color transform of the plurality of color transforms that has a lowest associated distortion cost.

100. The device of claim 78,
wherein the selected inverse color transform is an inverse color transform of the plurality of color transforms that is associated with a color space having a highest associated correlation between color components of the RGB color space and each of a plurality of color components associated with each of the plurality of color transforms.

101. The device of claim 100, wherein the received syntax data comprises syntax data of reconstructed neighboring blocks relative to at least one of the first block and the second block,
wherein the at least one processor is further configured to: determining the highest associated correlation based on the syntax data of the reconstructed neighboring blocks.

102. The device of claim 100, wherein the at least one processor is further configured to: decode an index syntax element that indicates the selected inverse color transform that has the highest associated correlation.

103. The device of claim 78, wherein the first block of data comprises a block of a reconstructed signal.

104. The device of claim 78, wherein the first block of video data comprises a block of a reconstructed residual signal,
wherein the first block comprises at least one of a group consisting of: a predictive block and a residual block.

105. A device for decoding video, the device comprising:
means for receiving syntax data associated with a coded unit in a bitstream, the syntax data indicative of one of a plurality of inverse color transforms;
means for selecting an inverse color transform of the plurality of inverse color transforms based on the received syntax data;
means for inversely transforming a first block of video data having a first color space to a second block of video having a second, red, green, blue (RGB) color space using the selected inverse color transform of the plurality of inverse color transforms; and
means for decoding the second video block having the second, RGB color space.

106. A non-transitory computer-readable storage medium having instructions stored thereon that, when executed, cause at least one processor to:
receive syntax data associated with a coded unit in a bitstream, the syntax data indicative of one of a plurality of inverse color transforms;
select an inverse color transform of the plurality of inverse color transforms based on the received syntax data;
inversely transforming a first block of video data having a first color space to a second block of video having a second, red, green, blue (RGB) color space using the selected inverse color transform of the plurality of inverse color transforms; and
decode the second video block having the second, RGB color space.
